(19) United States
(12) Patent Application Publication
(10) Pub. No.: US 2015/0134271 A1
(43) Pub. Date: May 14, 2015

(54) LIFE EXPIRATION PREDICTING METHOD, LIFE EXPIRATION PREDICTING APPARATUS, LIFE EXPIRATION PREDICTING SYSTEM, LIFE EXPIRATION CALCULATING APPARATUS, AND ROTARY MACHINE

(71) Applicant: SEIKO EPSON CORPORATION, Tokyo (JP)

(72) Inventors: Masahisa IKEJIRI, Fuchu-shi (JP); Kanae MATSUMURA, Fuchu-shi (JP); Shuichi IGUCHI, Ina-shi (JP)

(21) Appl. No.: 14/535,140

(22) Filed: Nov. 6, 2014

(30) Foreign Application Priority Data
Nov. 8, 2013 (JP) 2013-231917

(51) Int. Cl. G01N 19/00; B06B 1/10; G01M 99/00

(52) U.S. Cl. CPC G01N 19/00; G01M 99/00; B06B 1/10
USPC 702/34

(57) ABSTRACT

A vibration waveform output by a gyro sensor set in a main pump is received. The vibration waveform is subjected to a frequency analysis and a frequency spectrum is calculated. A feature value is calculated from the frequency spectrum. Life expiration of the main pump is determined using the feature value. When the feature value is represented as R, a sum of squares of amplitudes in the frequency spectrum is represented as D, and a sum of squares of the amplitudes exceeding a first determination value is represented as P, R=√(P/D).

### BACKGROUND

1. Technical Field

The present invention relates to a life expiration predicting method, a life expiration predicting apparatus, a life expiration predicting system, a life expiration calculating apparatus, and a rotary machine.

2. Related Art

Various rotary machines such as a semiconductor apparatus and a machine tool include rotating mechanisms driven by motors and the like. The rotating mechanisms are deteriorated in performance by friction and deposits and finally lose functions thereof. The loss of functions due to aged deterioration is called life expiration. When an apparatus stops functioning during manufacturing of a dry pump, workpiece becomes defective. Therefore, a method of diagnosing life expiration of the apparatus has been devised to perform maintenance of the apparatus before the life expiration of the apparatus.

JP-A-2004-117253 (Patent Literature 1) discloses a method of diagnosing life expiration of an apparatus. According to the method, a sensor for detecting vibration is set in the apparatus. A vibration waveform is subjected to a frequency analysis and a power spectrum is calculated. Subsequently, a frequency of reference vibration is selected according to the power spectrum and time-series data of the power spectrum of the reference vibration is created. When a value of the power spectrum exceeds a determination value, it is determined that the apparatus is near life expiration.

In the life expiration predicting method of Patent Literature 1, the time-series data of the power spectrum of the reference vibration is accumulated from the start of operation of the target apparatus of the life expiration prediction. The determination value is set from the time-series data. When the value of the power spectrum exceeds the determination value, it is determined that the apparatus is near life expiration. Therefore, a function of storing and managing data is necessary. When the target apparatus is changed, the reference vibration changes. Therefore, time series data of a power spectrum of the same apparatus is necessary to perform the life expiration prediction. When there are a large number of target apparatuses of the life expiration prediction, a large number of sensors are necessary. It is difficult to carry out the method. Therefore, there is a demand for a method that can predict life expiration of an apparatus even if there is no time-series data of a target apparatus.

### SUMMARY

An advantage of some aspects of the invention is to solve the problems described above, and the invention can be implemented as the following forms or application examples.

### Application Example 1

This application example is directed to a life expiration predicting method including: subjecting a vibration waveform output by an inertial sensor set in a detection target apparatus to a frequency analysis and calculating a frequency spectrum; calculating a feature value using the frequency spectrum; and determining life expiration of the detection target apparatus using the feature value. When the feature value is represented as R, a sum of squares of amplitudes in the frequency spectrum is represented as D, and a sum of squares of the amplitudes exceeding a first determination value is represented as P, R=√(P/D).

According to this application example, the inertial sensor is set in the detection target apparatus. The detection target apparatus vibrates. The inertial sensor outputs a vibration waveform that indicates a change with time of the vibration. Subsequently, the vibration waveform is subjected to a frequency analysis and a frequency spectrum is calculated. A feature value is calculated from the frequency spectrum.

The first determination value is set in the calculation of the feature value. A sum of squares of amplitudes exceeding the first determination value is calculated. A result of the calculation is represented as P. Subsequently, a sum of squares of amplitudes is calculated. A result of the calculation is represented as D. R=√(P/D) is set as the feature value.

A value of P decreases and a value of D increases as the detection target apparatus approaches the life expiration after starting operation. Therefore, a value of the feature value R decreases as the detection target apparatus approaches the life expiration. Since there is a correlation between the feature value and the life expiration, it is possible to detect the life expiration of the detection target apparatus using the feature value.

The feature value is calculated from a frequency spectrum of a frequency in a predetermined range. Therefore, a determination method can be used for apparatuses having the same structure. Since life expiration is determined with a feature value during measurement, it is possible to predict the life expiration of the detection target apparatus even if there is no individual time-series data of the detection target apparatus.

### Application Example 2

This application example is directed to a life expiration predicting method including: subjecting a vibration waveform output by an inertial sensor set in a detection target apparatus to a frequency analysis and calculating a frequency spectrum; calculating a feature value using the frequency spectrum; and determining life expiration of the detection target apparatus using the feature value. When the feature value is represented as R, a sum of squares of amplitudes in the frequency spectrum is represented as D, and a sum of squares of the amplitudes exceeding a first determination value is represented as P, R=√(D−P)/√D.

According to this application example, the inertial sensor is set in the detection target apparatus. The detection target apparatus vibrates. The inertial sensor outputs a vibration waveform that indicates a change with time of the vibration. Subsequently, the vibration waveform is subjected to a frequency analysis and a frequency spectrum is calculated. A feature value is calculated from the frequency spectrum.

The first determination value is set in the calculation of the feature value. A sum of squares of amplitudes exceeding the first determination value is calculated. A result of the calculation is represented as P. Subsequently, a sum of squares of amplitudes is calculated. A result of the calculation is represented as D. R=√(D−P)/√D is set as the feature value.

A value of P decreases and a value of D increases as the detection target apparatus approaches the life expiration after starting operation. Therefore, a value of the feature value R approaches 1 as the detection target apparatus approaches the life expiration. Since there is a correlation between the feature value and the life expiration, it is possible to determine the life expiration of the detection target apparatus using the feature value.

The feature value is calculated from a frequency spectrum of a frequency in a predetermined range. Therefore, a determination method can be used for apparatuses having the same structure. Since life expiration is determined with a feature value during measurement, it is possible to predict the life expiration of the detection target apparatus even if there is no individual time-series data of the detection target apparatus.

### Application Example 3

This application example is directed to the life expiration predicting method according to the application example described above, wherein a rate of change of the feature value with respect to an operation time is calculated, and the life expiration of the detection target apparatus is determined using the rate of change.

According to this application example, a rate of change of the feature value with respect to an operation time is calculated. The life expiration of the detection target apparatus is determined using the rate of change. The rate of change increases as the detection target apparatus approaches the life expiration. The rate of change changes larger than the feature value. Therefore, it is possible to make it easy to determine the life expiration by using the rate of change.

### Application Example 4

This application example is directed to the life expiration predicting method according to the application example described above, wherein the feature value and a second determination value are compared to determine the life expiration of the detection target apparatus.

According to this application example, the feature value and the second determination value are compared to determine the life expiration of the detection target apparatus. Therefore, it is possible to easily and clearly determine the life expiration.

### Application Example 5

This application example is directed to the life expiration predicting method according to the application example described above, wherein the vibration waveform output by the inertial sensor includes vibration components of the detection target apparatus in a first direction, a second direction, and a third direction orthogonal to one another, the life expiration predicting method further includes: calculating the frequency spectrums and the feature values in the first direction, the second direction, and the third direction; calculating a combined feature value using the feature values in the first direction, the second direction, and the third direction; and determining the life expiration of the detection target apparatus using the combined feature value, and, when the feature value calculated using the vibration waveform in the first direction is represented as R1, the feature value calculated using the vibration waveform in the second direction is represented as R2, and the feature value calculated using the vibration waveform in the third direction is represented as R3, RM=\sqrt{R₁²+R₂²+R₃²} is set as the combined feature value.

According to this application example, the inertial sensor detects vibrations of the detection target apparatus in the first direction, the second direction, and the third direction orthogonal to one another. The inertial sensor outputs vibration waveforms in the first direction, the second direction, and the third direction. The vibration waveforms in the three directions are subjected to a frequency analysis and frequency spectra and feature values in the respective directions are calculated. A combined feature value is calculated using the feature values in the three directions. Therefore, the combined feature value is data that indicates states of the vibrations in the three directions. As a result, it is possible to determine the life expiration of the detection target apparatus irrespective of a direction of the inertial sensor with respect to the detection target apparatus.

### Application Example 6

This application example is directed to a life expiration predicting method including: subjecting a vibration waveform output by an inertial sensor set in a detection target apparatus to a frequency analysis and calculating a frequency spectrum; calculating a feature value using the frequency spectrum; and determining life expiration of the detection target apparatus using the feature value. When the feature value is represented as R, a sum of squares of amplitudes in the frequency spectrum is represented as D, and a sum of squares of the amplitudes exceeding a first determination value is represented as P, R=P/D.

According to this application example, calculation of a square root is omitted in the calculation of the expression “R=P/D” compared with the calculation of the expression “R=√(P/D)”. Therefore, a calculation time can be reduced. In this case, as in the first and second application examples, the feature value is calculated from a frequency spectrum of a frequency in a predetermined range. Therefore, a determination method can be used for apparatuses having the same structure. Since life expiration is determined with a feature value during measurement, it is possible to predict the life expiration of the detection target apparatus even if there is no individual time-series data of the detection target apparatus.

### Application Example 7

This application example is directed to a life expiration predicting method including: subjecting a vibration waveform output by an inertial sensor set in a detection target apparatus to a frequency analysis and calculating a frequency spectrum; calculating a feature value using the frequency spectrum; and determining life expiration of the detection target apparatus using the feature value. When the feature value is represented as R, a sum of squares of amplitudes in the frequency spectrum is represented as D, and a sum of squares of the amplitudes exceeding a first determination value is represented as P, R=(D−P)/D.

According to this application example, calculation of a square root is omitted in the calculation of the expression “R=(D−P)/D” compared with the calculation of the expression “R=√(D−P)/√D”. Therefore, a calculation time can be reduced. The feature value is calculated from a frequency spectrum of a frequency in a predetermined range. Therefore, a determination method can be used for apparatuses having the same structure. Since life expiration is determined with a feature value during measurement, it is possible to predict the life expiration of the detection target apparatus even if there is no individual time-series data of the detection target apparatus.

### Application Example 8

This application example is directed to a life expiration predicting apparatus including: an inertial sensor set in a detection target apparatus and configured to output a vibration waveform of the detection target apparatus; a spectrum calculating unit configured to subject the vibration waveform to a frequency analysis and calculate a frequency spectrum; a feature-value calculating unit configured to calculate a feature value using the frequency spectrum; and a determining unit configured to determine life expiration of the detection target apparatus using the feature value. When the feature value is represented as R, a sum of squares of amplitudes in the frequency spectrum is represented as D, and a sum of squares of the amplitudes exceeding a first determination value is represented as P, R=√(P/D).

According to this application example, the inertial sensor is set in the detection target apparatus. The detection target apparatus vibrates. The inertial sensor outputs a vibration waveform that indicates a change with time of the vibration. Subsequently, the spectrum calculating unit subjects the vibration waveform to a frequency analysis and calculates a frequency spectrum. The feature-value calculating unit calculates a feature value from the frequency spectrum.

The first determination value is set in the calculation of the feature value. The feature-value calculating unit calculates a sum of squares of amplitudes exceeding the first determination value. A result of the calculation is represented as P. Further, the feature-value calculating unit calculates a sum of squares of amplitudes. A result of the calculation is represented as D. The feature-value calculating unit calculates an expression “R=√(P/D)” and sets R=√(P/D) as the feature value.

A value of P decreases and a value of D increases as the detection target apparatus approaches the life expiration after starting operation. Therefore, a value of the feature value R decreases as the detection target apparatus approaches the life expiration. Since there is a correlation between the feature value and the life expiration, the life expiration predicting apparatus can detect the life expiration of the detection target apparatus using the feature value.

The feature value is calculated from a frequency spectrum of a frequency in a predetermined range. Therefore, a determination method can be used for apparatuses having the same structure. Since life expiration is determined with a feature value during measurement, it is possible to predict the life expiration of the detection target apparatus even if there is no individual time-series data of the detection target apparatus.

### Application Example 9

This application example is directed to a life expiration predicting apparatus including: an inertial sensor set in a detection target apparatus and configured to output a vibration waveform of the detection target apparatus; a spectrum calculating unit configured to subject the vibration waveform to a frequency analysis and calculate a frequency spectrum; a feature-value calculating unit configured to calculate a feature value using the frequency spectrum; and a determining unit configured to determine life expiration of the detection target apparatus using the feature value. When the feature value is represented as R, a sum of squares of amplitudes in the frequency spectrum is represented as D, and a sum of squares of the amplitudes exceeding a first determination value is represented as P, R=√(D−P)/√D.

According to this application example, the inertial sensor is set in the detection target apparatus. The detection target apparatus vibrates. The inertial sensor outputs a vibration waveform that indicates a change with time of the vibration. Subsequently, the spectrum calculating unit subjects the vibration waveform to a frequency analysis and calculates a frequency spectrum. The feature-value calculating unit calculates a feature value from the frequency spectrum.

The first determination value is set in the calculation of the feature value. The feature-value calculating unit calculates a sum of squares of amplitudes exceeding the first determination value. A result of the calculation is represented as P. Further, the feature-value calculating unit calculates a sum of squares of amplitudes. A result of the calculation is represented as D. The feature-value calculating unit calculates an expression “R=√(D−P)/√D” and sets R=√(D−P)/√D as the feature value.

A value of P decreases and a value of D increases as the detection target apparatus approaches the life expiration after starting operation. Therefore, a value of the feature value R approaches 1 as the detection target apparatus approaches the life expiration. Since there is a correlation between the feature value and the life expiration, the life expiration predicting apparatus can determine the life expiration of the detection target apparatus using the feature value.

The feature value is calculated from a frequency spectrum of a frequency in a predetermined range. Therefore, a determination method can be used for apparatuses having the same structure. Since life expiration is determined with a feature value during measurement, it is possible to predict the life expiration of the detection target apparatus even if there is no individual time-series data of the detection target apparatus.

### Application Example 10

This application example is directed to the life expiration predicting apparatus according to the application example described above, wherein the inertial sensor is a gyro sensor.

According to this application example, the inertial sensor is a gyro sensor. The inertial sensor includes an acceleration sensor that detects acceleration and a gyro sensor that detects angular velocity. A feature value calculated from a vibration waveform output by the acceleration sensor is set as an acceleration feature value. A feature value calculated from a vibration waveform output by the gyro sensor is set as an angular velocity feature value. In this case, the angular velocity feature value generally has a larger correlation with the life expiration of the detection target apparatus compared with the acceleration feature value. Therefore, the life expiration of the detection target apparatus can be more easily determined when the gyro sensor is used as the inertial sensor.

### Application Example 11

This application example is directed to a life expiration predicting system in which a vibration detecting apparatus and a life expiration calculating apparatus are communicably connected via a network. The vibration detecting apparatus includes: an inertial sensor set in a detection target apparatus and configured to output a vibration waveform of the detection target apparatus; and a transmitting unit configured to transmit the vibration waveform to the life expiration calculating apparatus. The life expiration calculating apparatus includes: a receiving unit configured to receive the vibration waveform from the vibration detecting apparatus; a spectrum calculating unit configured to subject the vibration waveform to a frequency analysis and calculate a frequency spectrum; a feature-value calculating unit configured to calculate a feature value using the frequency spectrum; and a determining unit configured to determine life expiration of the detection target apparatus using the feature value. When the feature value is represented as R, a sum of squares of amplitudes in the frequency spectrum is represented as D, and a sum of squares of the amplitudes exceeding a first determination value is represented as P, R=√(P/D).

According to this application example, in the life expiration predicting system, the vibration detecting apparatus and the life expiration calculating apparatus are communicably connected via the network. The vibration detecting apparatus includes the inertial sensor and the transmitting unit. The inertial sensor is set in the detection target apparatus. The detection target apparatus vibrates. The inertial sensor outputs a vibration waveform that indicates a change with time of the vibration. The transmitting unit transmits the vibration waveform to the life expiration calculating apparatus via the network.

The life expiration calculating apparatus includes the receiving unit, the spectrum calculating unit, the feature-value calculating unit, and the determining unit. The receiving unit receives the vibration waveform. The spectrum calculating unit subjects the vibration waveform to a frequency analysis and calculates a frequency spectrum. The first determination value is set in the calculation of the feature value. The feature-value calculating unit calculates a sum of squares of amplitudes exceeding the first determination value. A result of the calculation is represented as P. Further, the feature-value calculating unit calculates a sum of squares of amplitudes. A result of the calculation is represented as D. The feature-value calculating unit calculates an expression “R=√(P/D)” and sets R=√(P/D) as the feature value. The determining unit determines the life expiration of the detection target apparatus using the feature value.

A value of P decreases and a value of D increases as the detection target apparatus approaches the life expiration after starting operation. Therefore, a value of the feature value R decreases as the detection target apparatus approaches the life expiration. Since there is a correlation between the feature value and the life expiration, the life expiration predicting apparatus can detect the life expiration of the detection target apparatus using the feature value. The vibration detecting apparatus and the life expiration calculating apparatus are connected via the network. Therefore, when a plurality of the vibration detecting apparatuses are connected to the network, the life expiration calculating apparatus can also determine life expiration of the plurality of the detection target apparatuses.

The feature value is calculated from a frequency spectrum of a frequency in a predetermined range. Therefore, a determination method can be used for apparatuses having the same structure. Since life expiration is determined with a feature value during measurement, it is possible to predict the life expiration of the detection target apparatus even if there is no individual time-series data of the detection target apparatus.

### Application Example 12

This application example is directed to a life expiration predicting system in which a vibration detecting apparatus and a life expiration calculating apparatus are communicably connected via a network. The vibration detecting apparatus includes: an inertial sensor set in a detection target apparatus and configured to output a vibration waveform of the detection target apparatus; and a transmitting unit configured to transmit the vibration waveform to the life expiration calculating apparatus. The life expiration calculating apparatus includes: a receiving unit configured to receive the vibration waveform; a spectrum calculating unit configured to subject the vibration waveform to a frequency analysis and calculate a frequency spectrum; a feature-value calculating unit configured to calculate a feature value using the frequency spectrum; and a determining unit configured to determine life expiration of the detection target apparatus using the feature value. When the feature value is represented as R, a sum of squares of amplitudes in the frequency spectrum is represented as D, and a sum of squares of the amplitudes exceeding a first determination value is represented as P, R=√(D−P)/√D.

According to this application example, in the life expiration predicting system, the vibration detecting apparatus and the life expiration calculating apparatus are communicably connected via the network. The vibration detecting apparatus includes the inertial sensor and the transmitting unit. The inertial sensor is set in the detection target apparatus. The detection target apparatus vibrates. The inertial sensor outputs a vibration waveform that indicates a change with time of the vibration. The transmitting unit transmits the vibration waveform to the life expiration calculating apparatus via the network.

The life expiration calculating apparatus includes the receiving unit, the spectrum calculating unit, the feature-value calculating unit, and the determining unit. The receiving unit receives the vibration waveform. The spectrum calculating unit subjects the vibration waveform to a frequency analysis and calculates a frequency spectrum. The first determination value is set in the calculation of the feature value. The feature-value calculating unit calculates a sum of squares of amplitudes exceeding the first determination value. A result of the calculation is represented as P. Further, the feature-value calculating unit calculates a sum of squares of amplitudes. A result of the calculation is represented as D. The feature-value calculating unit calculates an expression “R=√(D−P)/√D” and sets R=√(D−P)/√D as the feature value. The determining unit determines the life expiration of the detection target apparatus using the feature value.

A value of P decreases and a value of D increases as the detection target apparatus approaches the life expiration after starting operation. Therefore, a value of the feature value R approaches 1 as the detection target apparatus approaches the life expiration. Since there is a correlation between the feature value and the life expiration, the life expiration predicting apparatus can determine the life expiration of the detection target apparatus using the feature value. The vibration detecting apparatus and the life expiration calculating apparatus are connected via the network. Therefore, when a plurality of the vibration detecting apparatuses are connected to the network, the life expiration calculating apparatus can also determine life expiration of the plurality of the detection target apparatuses.

The feature value is calculated from a frequency spectrum of a frequency in a predetermined range. Therefore, a determination method can be used for apparatuses having the same structure. Since life expiration is determined with a feature value during measurement, it is possible to predict the life expiration of the detection target apparatus even if there is no individual time-series data of the detection target apparatus.

### Application Example 13

This application example is directed to a life expiration calculating apparatus used in a system in which the life expiration calculating apparatus is communicably connected to a vibration detecting apparatus via a network. The life expiration calculating apparatus includes: a receiving unit configured to receive a vibration waveform of a detection target apparatus transmitted by the vibration detecting apparatus; a spectrum calculating unit configured to subject the vibration waveform to a frequency analysis and calculate a frequency spectrum; a feature-value calculating unit configured to calculate a feature value using the frequency spectrum; and a determining unit configured to determine life expiration of the detection target apparatus using the feature value. When the feature value is represented as R, a sum of squares of amplitudes in the frequency spectrum is represented as D, and a sum of squares of the amplitudes exceeding a first determination value is represented as P, R=√(P/D).

According to this application example, in the life expiration predicting system, the vibration detecting apparatus and the life expiration calculating apparatus are communicably connected via the network. The detection target apparatus vibrates during operation. The vibration detecting apparatus outputs, to the life expiration calculating apparatus via the network, a vibration waveform that indicates a change with time of the vibration of the detection target apparatus.

The life expiration calculating apparatus includes the receiving unit, the spectrum calculating unit, the feature-value calculating unit, and the determining unit. The receiving unit receives the vibration waveform. The spectrum calculating unit subjects the vibration waveform to a frequency analysis and calculates a frequency spectrum. The first determination value is set in the calculation of the feature value. The feature-value calculating unit calculates a sum of squares of amplitudes exceeding the first determination value. A result of the calculation is represented as P. Further, the feature-value calculating unit calculates a sum of squares of amplitudes. A result of the calculation is represented as D. The feature-value calculating unit calculates a value of an expression “R=√(P/D)” and sets R=√(P/D) as the feature value. The determining unit determines the life expiration of the detection target apparatus using the feature value.

A value of P decreases and a value of D increases as the detection target apparatus approaches the life expiration after starting operation. Therefore, a value of the feature value R decreases as the detection target apparatus approaches the life expiration. Since there is a correlation between the feature value and the life expiration, the life expiration predicting apparatus can detect the life expiration of the detection target apparatus using the feature value. The vibration detecting apparatus and the life expiration calculating apparatus are connected via the network. Therefore, when a plurality of the vibration detecting apparatuses are connected to the network, the life expiration calculating apparatus can also determine life expiration of the plurality of the detection target apparatuses.

The feature value is calculated from a frequency spectrum of a frequency in a predetermined range. Therefore, a determination method can be used for apparatuses having the same structure. Since life expiration is determined with a feature value during measurement, it is possible to predict the life expiration of the detection target apparatus even if there is no individual time-series data of the detection target apparatus.

### Application Example 14

This application example is directed to a life expiration calculating apparatus used in a system in which the life expiration calculating apparatus is communicably connected to a vibration detecting apparatus via a network. The life expiration calculating apparatus includes: a receiving unit configured to receive a vibration waveform of a detection target apparatus transmitted by the vibration detecting apparatus; a spectrum calculating unit configured to subject the vibration waveform to a frequency analysis and calculate a frequency spectrum; a feature-value calculating unit configured to calculate a feature value using the frequency spectrum; and a determining unit configured to determine life expiration of the detection target apparatus using the feature value. When the feature value is represented as R, a sum of squares of amplitudes in the frequency spectrum is represented as D, and a sum of squares of the amplitudes exceeding a first determination value is represented as P, R=√(D−P)/√D.

According to this application example, in the life expiration predicting system, the vibration detecting apparatus and the life expiration calculating apparatus are communicably connected via the network. The detection target apparatus vibrates during operation. The vibration detecting apparatus outputs, to the life expiration calculating apparatus via the network, a vibration waveform that indicates a change with time of the vibration of the detection target apparatus.

The life expiration calculating apparatus includes the receiving unit, the spectrum calculating unit, the feature-value calculating unit, and the determining unit. The receiving unit receives the vibration waveform. The spectrum calculating unit subjects the vibration waveform to a frequency analysis and calculates a frequency spectrum. The first determination value is set in the calculation of the feature value. The feature-value calculating unit calculates a sum of squares of amplitudes exceeding the first determination value. A result of the calculation is represented as P. Further, the feature-value calculating unit calculates a sum of squares of amplitudes. A result of the calculation is represented as D. The feature-value calculating unit calculates a value of an expression “R=√(D−P)/√D” and sets R=√(D−P)/√D as the feature value. The determining unit determines the life expiration of the detection target apparatus using the feature value.

A value of P decreases and a value of D increases as the detection target apparatus approaches the life expiration after starting operation. Therefore, a value of the feature value R approaches 1 as the detection target apparatus approaches the life expiration. Since there is a correlation between the feature value and the life expiration, the life expiration predicting apparatus can detect the life expiration of the detection target apparatus using the feature value. The vibration detecting apparatus and the life expiration calculating apparatus are connected via the network. Therefore, when a plurality of the vibration detecting apparatuses are connected to the network, the life expiration calculating apparatus can also determine life expiration of the plurality of the detection target apparatuses.

The feature value is calculated from a frequency spectrum of a frequency in a predetermined range. Therefore, a determination method can be used for apparatuses having the same structure. Since life expiration is determined with a feature value during measurement, it is possible to predict the life expiration of the detection target apparatus even if there is no individual time-series data of the detection target apparatus.

### Application Example 15

This application example is directed to a rotary machine including: a rotating unit; an inertial sensor configured to output a vibration waveform of the rotating unit; a spectrum calculating unit configured to subject the vibration waveform to a frequency analysis and calculate a frequency spectrum; a feature-value calculating unit configured to calculate a feature value using the frequency spectrum; and a determining unit configured to determine life expiration of the rotary machine using the feature value. When the feature value is represented as R, a sum of squares of amplitudes in the frequency spectrum is represented as D, and a sum of squares of the amplitudes exceeding a first determination value is represented as P, R=√(P/D).

According to this application example, the inertial sensor is set in the rotary machine. The rotating unit vibrates the rotary machine. The inertial sensor detects the vibration of the rotary machine. The inertial sensor outputs a vibration waveform that indicates a change with time of the vibration. Subsequently, the spectrum calculating unit subjects the vibration waveform to a frequency analysis and calculates a frequency spectrum. The feature-value calculating unit calculates a feature value from the frequency spectrum.

The first determination value is set in the calculation of the feature value. The feature-value calculating unit calculates a sum of squares of amplitudes exceeding the first determination value. A result of the calculation is represented as P. Further, the feature-value calculating unit calculates a sum of squares of amplitudes. A result of the calculation is represented as D. The feature-value calculating unit calculates an expression “R=√(P/D)” and sets R=√(P/D) as the feature value.

A value of P decreases and a value of D increases as the rotary machine approaches the life expiration after starting operation. Therefore, a value of the feature value R decreases as the rotary machine approaches the life expiration. Since there is a correlation between the feature value and the life expiration, the determining unit can detect the life expiration of the rotary machine using the feature value.

The feature value is calculated from a frequency spectrum of a frequency in a predetermined range. Therefore, a determination method can be used for apparatuses having the same structure. Since life expiration is determined with a feature value during measurement, it is possible to predict the life expiration of the rotary machine even if there is no individual time-series data of the rotary machine.

### Application Example 16

This application example is directed to a rotary machine including: a rotating unit; an inertial sensor configured to output a vibration waveform of the rotating unit; a spectrum calculating unit configured to subject the vibration waveform to a frequency analysis and calculate a frequency spectrum; a feature-value calculating unit configured to calculate a feature value using the frequency spectrum; and a determining unit configured to determine life expiration of the rotary machine using the feature value. When the feature value is represented as R, a sum of squares of amplitudes in the frequency spectrum is represented as D, and a sum of squares of the amplitudes exceeding a first determination value is represented as P, R=√(D−P)/√D.

According to this application example, the inertial sensor is set in the rotary machine. The rotating unit vibrates the rotary machine. The inertial sensor detects the vibration of the rotary machine. The inertial sensor outputs a vibration waveform that indicates a change with time of the vibration. Subsequently, the spectrum calculating unit subjects the vibration waveform to a frequency analysis and calculates a frequency spectrum. The feature-value calculating unit calculates a feature value from the frequency spectrum.

The first determination value is set in the calculation of the feature value. The feature-value calculating unit calculates a sum of squares of amplitudes exceeding the first determination value. A result of the calculation is represented as P. Further, the feature-value calculating unit calculates a sum of squares of amplitudes. A result of the calculation is represented as D. The feature-value calculating unit calculates an expression “R=√(D−P)/√D” and sets R=√(D−P)/√D as the feature value.

A value of P decreases and a value of D increases as the rotary machine approaches the life expiration after starting operation. Therefore, a value of the feature value R approaches 1 as the rotary machine approaches the life expiration. Since there is a correlation between the feature value and the life expiration, the determining unit can detect the life expiration of the rotary machine using the feature value.

The feature value is calculated from a frequency spectrum of a frequency in a predetermined range. Therefore, a determination method can be used for apparatuses having the same structure. Since life expiration is determined with a feature value during measurement, it is possible to predict the life expiration of the rotary machine even if there is no individual time-series data of the detection target apparatus.

### BRIEF DESCRIPTION OF THE DRAWINGS

The invention will be described with reference to the accompanying drawings, wherein like numbers reference like elements.

FIG. 1 is a block diagram showing the configuration of a dry etching apparatus according to a first embodiment.

FIG. 2A is a schematic perspective view showing the structure of a gyro sensor.

FIG. 2B is a flowchart of a life expiration predicting method.

FIGS. 3A and 3B are diagrams for explaining the life expiration predicting method.

FIGS. 4A to 4C are diagrams for explaining the life expiration predicting method.

FIGS. 5A to 5C are diagrams for explaining a life expiration predicting method according to a second embodiment.

FIGS. 6A and 6B are diagrams for explaining a life expiration predicting method according to a third embodiment.

FIGS. 7A and 7B are diagrams for explaining a life expiration predicting method according to a fourth embodiment.

FIG. 8 is a diagram for explaining a life expiration predicting method according to a fifth embodiment.

FIGS. 9A and 9B are diagrams for explaining a life expiration predicting method according to a sixth embodiment.

FIG. 10 is a flowchart for explaining a life expiration predicting method according to a seventh embodiment.

FIG. 11 is a diagram for explaining the life expiration predicting method.

FIG. 12 is a diagram for explaining a life expiration predicting method according to an eighth embodiment.

FIG. 13 is a block diagram showing the configuration of a life expiration predicting system according to a ninth embodiment.

### DESCRIPTION OF EXEMPLARY EMBODIMENTS

In embodiments, characteristic examples of a characteristic life expiration predicting apparatus set in a rotary machine and a life expiration predicting method for detecting life expiration of the rotary machine using the life expiration predicting apparatus are explained. The embodiments are explained below with reference to the drawings. Note that members in the drawings are shown with scales varied for each of the members to set the sizes of the members to be recognizable on the drawings.

### First Embodiment

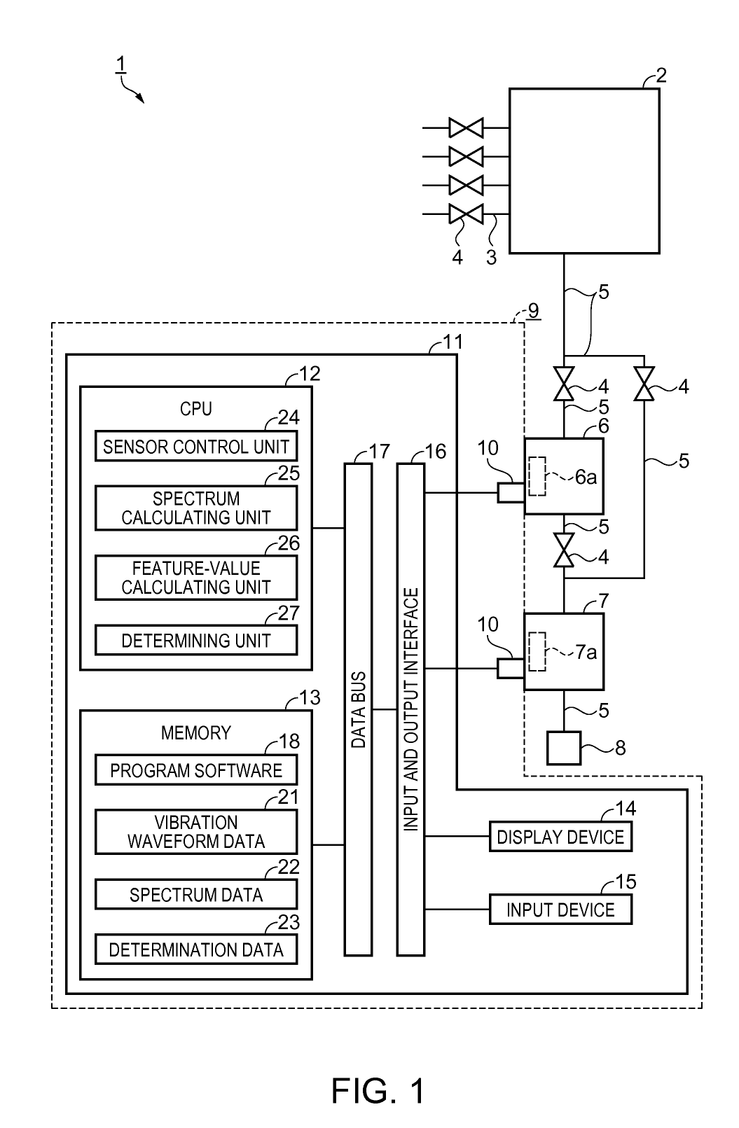

A life expiration predicting apparatus and a life expiration predicting method according to a first embodiment are explained with reference to FIGS. 1 to 4. FIG. 1 is a block diagram showing the configuration of a dry etching apparatus. As shown in FIG. 1, a dry etching apparatus 1 functioning as a rotary machine includes a chamber 2. A table on which a silicon wafer is mounted, a plasma generating device, an electrode that induces ions charged with plasma, and the like are set on the inside of the chamber 2.

Pipes 3 for supplying an etching gas and electromagnetic valves 4 that control a flow rate of the etching gas are connected to the chamber 2. A pipe 5 for exhaust is connected to the chamber 2. The pipe 5 is set in a main pump 6 and a roughing vacuum pump 7. The main pump 6 and the roughing vacuum pump 7 are connected by the pipe 5. The electromagnetic valve 4 is set in the pipe 5 between the chamber 2 and the main pump 6. The electromagnetic valve 4 is also set in the pipe 5 between the chamber 2 and the roughing vacuum pump 7. Further, the electromagnetic valve 4 is also set in the pipe 5 between the main pump 6 and the roughing vacuum pump 7. The roughing vacuum pump 7 is connected to an exhaust treatment device 8 via the pipe 5. The exhaust treatment device 8 is a device that separates and removes toxic substances from an exhaust gas.

The chamber 2 is decompressed when a silicon wafer is etched in the chamber 2. First, the dry etching apparatus 1 drives the roughing vacuum pump 7 to exhaust gas in the chamber 2. Subsequently, the dry etching apparatus 1 drives the main pump 6 to increase a vacuum degree in the chamber 2. The dry etching apparatus 1 closes the electromagnetic valves 4 of the pipe 5. The dry etching apparatus 1 opens the electromagnetic valves 4 of the pipes 3 to supply an etching gas to the chamber 2. When the etching gas reaches predetermined concentration, the dry etching apparatus 1 closes the electromagnetic valves 4 of the pipes 3. The dry etching apparatus 1 starts etching of the silicon wafer.

CF4 or CHF3 is used as the etching gas. Gas including AlF3 and C is generated by the etching. When the main pump 6 and the roughing vacuum pump 7 operate, product materials such as AlF3 and C deposit and accumulate in the main pump 6 and the roughing vacuum pump 7. When the accumulation of the product materials increases, the main pump 6 and the roughing vacuum pump 7 cause a malfunction and the life of the pumps expires.

A type of the main pump 6 and the roughing vacuum pump 7 is not particularly limited. However, for example, various pumps such as a diaphragm type, a swinging piston type, a rotary blade type, a mechanical booster type, a scroll type, a turbo molecular type, a rotary type, and a cryropump can be used. In this embodiment, for example, a dry pump is used as the main pump 6 and the roughing vacuum pump 7. A motor 6a is incorporated in the main pump 6. The motor 6a rotates and the main pump 6 operates. Therefore, when the main pump 6 operates, the main pump 6 vibrates. Similarly, a motor 7a is incorporated in the roughing vacuum pump 7. The motor 7a rotates and the roughing vacuum pump 7 operates. Therefore, when the roughing vacuum pump 7 operates, the roughing vacuum pump 7 vibrates.

A life expiration predicting apparatus 9 that detects life expiration is set for the main pump 6 and the roughing vacuum pump 7. The life predicting apparatus 9 includes gyro sensors 10 and an arithmetic device 11. The gyro sensors 10 are connected to the arithmetic device 11 by wires. The gyro sensors 10 are set in contact with the main pump 6 and the roughing vacuum pump 7. The main pump 6 and the roughing vacuum pump 7 swing according to the vibration. The gyro sensors 10 detect the vibration by detecting a change in rotating speed due to the swing. Methods with which the life expiration predicting apparatus 9 detects life expiration of the main pump 6 and life expiration of the roughing vacuum pump 7 are substantially the same. Therefore, to clarify the explanation, the method with which the life expiration predicting apparatus 9 detects life expiration of the main pump 6 is explained. Explanation of the method with which the life expiration predicting apparatus 9 detects life expiration of the roughing vacuum pump 7 is omitted.

As an inertial sensor that detects vibration, there are an acceleration sensor that detects acceleration and a gyro sensor that detects angular velocity. A feature value calculated from a vibration waveform output by the acceleration sensor is referred to as acceleration feature value. A feature value calculated from a vibration waveform output by the gyro sensor is referred to as angular velocity feature value. In this case, the angular velocity feature value generally has a larger correlation with the life expiration of the detection target apparatus compared with the acceleration feature value. Therefore, the life expiration of the detection target apparatus can be more easily determined when the gyro sensor is used as the inertial sensor.

The arithmetic device 11 includes a CPU 12 that performs various kinds of arithmetic processing and a memory 13 that stores various kinds of information. Further, the life expiration predicting apparatus 9 includes a display device 14 and an input device 15. The gyro sensor 10, the display device 14, and the input device 15 are connected to the CPU 12 via an input and output interface 16 and a data bus 17.

The display device 14 is a device configured by a liquid crystal display device or an OLED and configured to display a state of the life expiration predicting apparatus 9 and various data. The input device 15 is a device configured to input data such as a keyboard or a connection interface to an external apparatus. An operator can input various data using the input device 15 and check the data on the display device 14.

The memory 13 is a concept including semiconductor memories such as a RAM and a ROM and external storage devices such as a hard disk and a DVD-ROM. In terms of functions, a storage area for storing program software 18 describing acquisition of vibration data and various calculation procedures and a storage area for storing vibration waveform data 21 output by the gyro sensor 10 are set.

Besides, a storage area for storing spectrum data 22 serving as a frequency spectrum calculated by performing a Fourier operation of the vibration waveform data 21 is set. A storage area for storing determination data 23, which is data calculated from the spectrum data 22 and used for determination, is set. Further, a storage area functioning as a work area for the CPU 12, a temporary file, and the like and other various storage areas are set.

The CPU 12 performs, according to the program software 18 stored in the memory 13, control and an arithmetic operation for actuating the gyro sensor 10. The CPU 12 includes a sensor control unit 24 as a specific function realizing unit. The sensor control unit 24 outputs an instruction signal to the gyro sensor 10 and causes the gyro sensor 10 to detect vibration of the main pump 6. The sensor control unit 24 stores the vibration waveform data 21 output by the gyro sensor 10 in the memory 13.

Besides, the CPU 12 includes a spectrum calculating unit 25. The spectrum calculating unit 25 performs an arithmetic operation for performing Fourier transform using the vibration waveform data 21. The spectrum calculating unit 25 stores the spectrum data 22, which is a result of the arithmetic operation, in the memory 13. Besides, the CPU 12 includes a feature-value calculating unit 26. The feature-value calculating unit 26 processes the spectrum data 22 and calculates the determination data 23 used for life expiration determination. The feature-value calculating unit 26 stores the determination data 23 in the memory 13.

Besides, the CPU 12 includes a determining unit 27. The determining unit 27 determines, using the determination data 23, whether the main pump 6 and the roughing vacuum pump 7 are near the life expiration. The determining unit 27 displays a determination result on the display device 14.

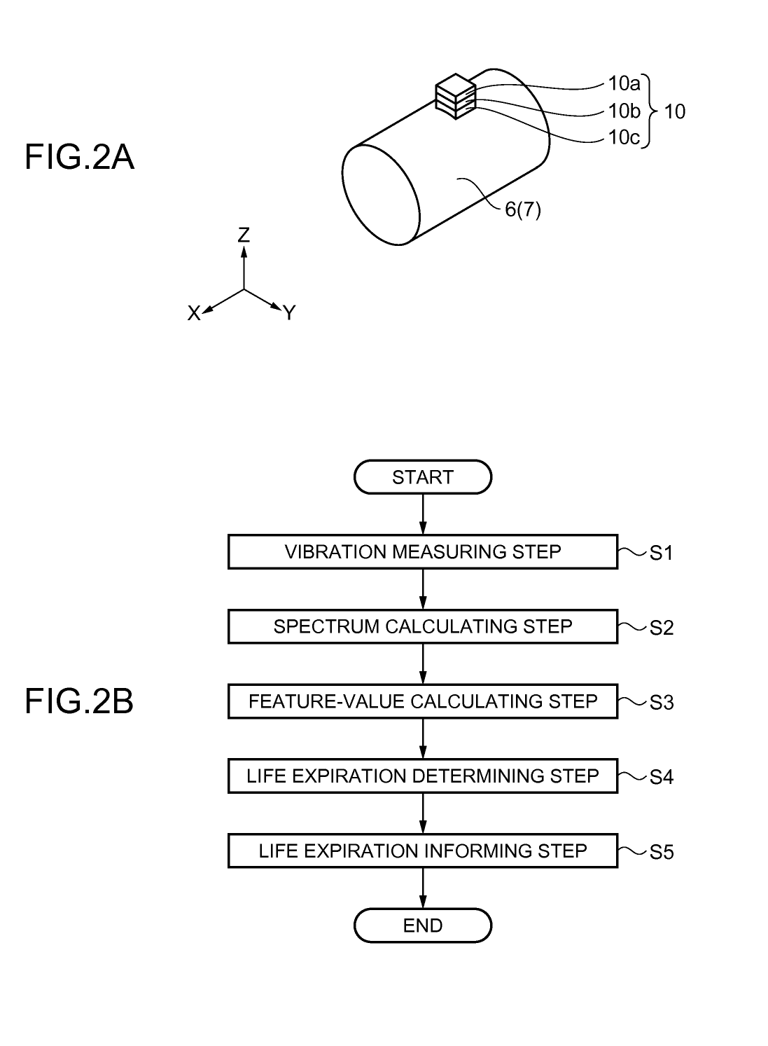

FIG. 2A is a schematic perspective view showing the structure of the gyro sensor 10. As shown in FIG. 2A, in the gyro sensor 10, an X-axis gyro sensor 10a, a Y-axis gyro sensor 10b, and a Z-axis gyro sensor 10c are set to be placed one on top of another. The X-axis gyro sensor 10a is a sensor that detects angular velocity with a rotation axis set in an X direction. The Y-axis gyro sensor 10b is a sensor that detects angular velocity with a rotation axis set in a Y direction. The Z-axis gyro sensor 10c is a sensor that detects angular velocity with a rotation axis set in a Z direction. The X direction, the Y direction, and the Z direction are directions orthogonal to one another. Therefore, when the main pump 6 swings, the gyro sensor 10 can detect the swing of the main pump 6 irrespective of which direction is set as a rotation axis for the swing. When the main pump 6 vibrates, the main pump 6 swings according to the vibration. Therefore, the gyro sensor 10 detects a waveform of angular velocity of the swing by the vibration of the main pump 6. The gyro sensor 10 outputs the waveform of the angular velocity as the vibration waveform data 21.

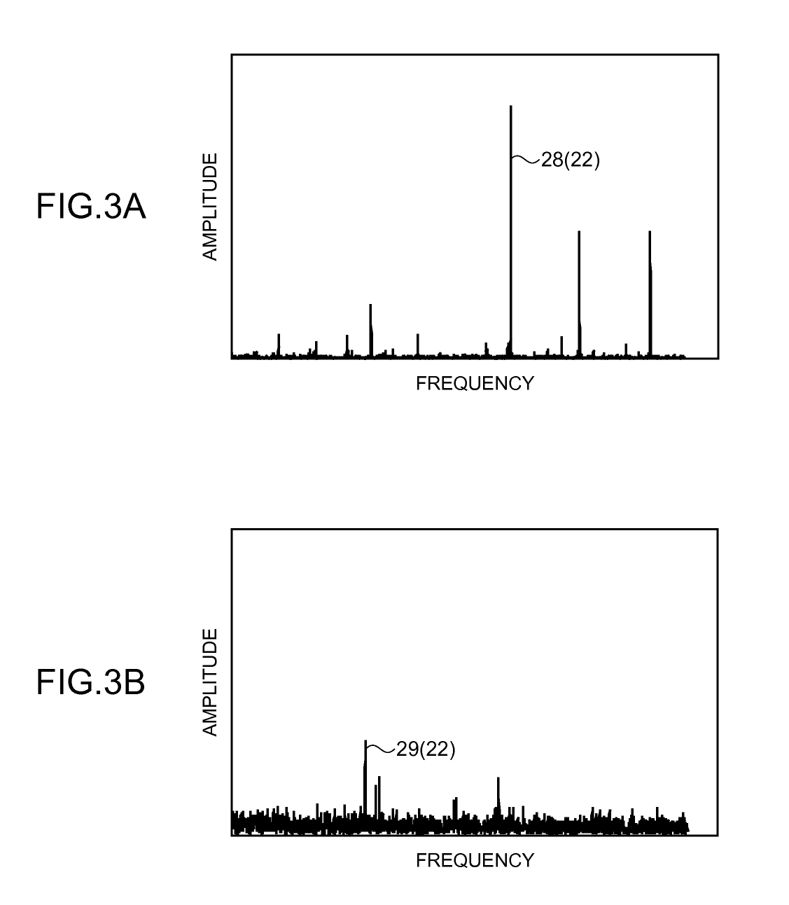

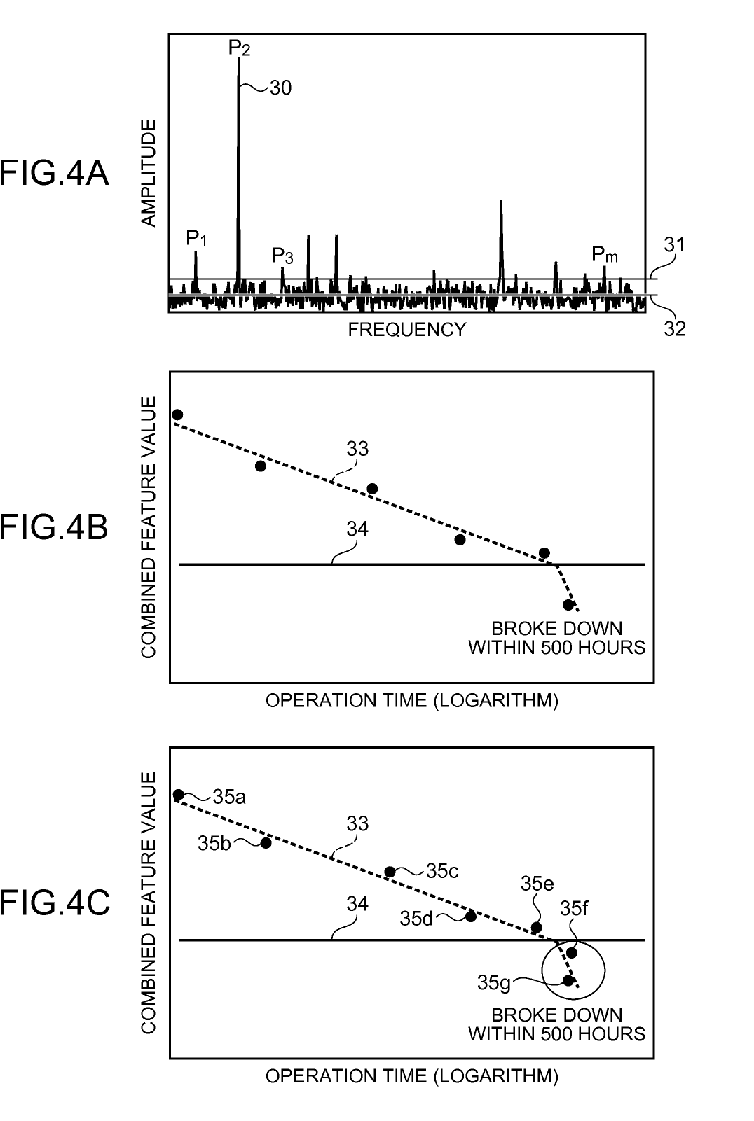

A life expiration predicting method for predicting life expiration using the life expiration predicting apparatus 9 is explained with reference to FIG. 2B to FIGS. 4A to 4C. FIG. 2B is a flowchart of the life expiration predicting method. FIGS. 3A and 3B and FIGS. 4A to 4C are diagrams for explaining a life expiration predicting method.

In the flowchart of FIG. 2B, step S1 is equivalent to a vibration measuring step. This step is a step in which the gyro sensor 10 detects a vibration waveform due to vibration of the main pump 6 and outputs the vibration waveform data 21 to the memory 13. Processing shifts to step S2. Step S2 is equivalent to a spectrum calculating step. This step is a step in which the spectrum calculating unit 25 Fourier-transforms the vibration waveform data 21 and outputs the spectrum data 22 to the memory 13. The processing shifts to step S3.

Step S3 is equivalent to a feature value calculating step. This step is a step in which the feature-value calculating unit 26 calculates, using the spectrum data 22, the determination data 23 used for determination of life expiration and outputs the determination data 23 to the memory 13. The processing shifts to step S4. Step S4 is equivalent to a life expiration determining step. This step is a step in which the determining unit 27 determines, using the determination data 23, whether the main pump 6 is near the life expiration. The processing shifts to step S5. Step S5 is equivalent to a life expiration informing step. This step is a step in which the determining unit 27 displays a determined result on the display device 14. The process for detecting the life expiration of the main pump 6 ends according to the steps explained above.

A life expiration predicting method is explained in detail with reference to FIGS. 3A and 3B and FIGS. 4A to 4C in association with the steps shown in FIG. 2B. In the vibration measuring step of step S1, the operator issues an instruction for starting measurement to the CPU 12 using the input device 15. Subsequently, the sensor control unit 24 outputs an instruction signal to the gyro sensor 10. The gyro sensor 10 receives the instruction signal and detects vibration of the main pump 6. The gyro sensor 10 outputs the vibration waveform data 21 to the memory 13 and stores the vibration waveform data 21 in the memory 13. A part of the vibration waveform data 21 is data indicating a waveform of a change with time of angular velocity at which the main pump 6 swings.

FIGS. 3A and 3B are diagrams corresponding to the spectrum calculating step of step S2. In step S2, the spectrum calculating unit 25 Fourier-transforms the vibration waveform data and calculates the spectrum data 22. As a result, as shown in FIGS. 3A and 3B, the spectrum data 22 such as a first frequency spectrum 28 and a second frequency spectrum 29 is obtained. In FIGS. 3A and 3B, the abscissa indicates a frequency and the ordinate indicates amplitude. Since the Fourier transform is a complex function, data after the transform is a complex number. The amplitude is a value obtained by adding up a square value of a real part and a square value of an imaginary part and calculating a square root. As the Fourier transform, FFT (Fast Fourier Transform) is used. Therefore, the spectrum data 22 such as the first frequency spectrum 28 and the second frequency spectrum 29 is a limited number of discrete data.

The first frequency spectrum 28 is a frequency spectrum in the main pump 6 in a state in which an operation time is short. The second frequency spectrum 29 is a frequency spectrum in the main pump 6 in a state in which an operation time is long. As indicated by the first frequency spectrum 28, the amplitude of a specific frequency is markedly prominent in the state in which the operation time is short. The amplitude is small at a frequency at which the amplitude is not prominent. As indicated by the second frequency spectrum 29, in the state in which the operation time is long, the amplitude of the frequency markedly prominent in the first frequency spectrum 28 decreases. The amplitude increases at frequencies other than the frequency at which the amplitude is prominent in the first frequency spectrum 28. Therefore, as the operation time of the main pump 6 increases, the amplitude in a place where the amplitude is prominent decreases and the amplitude in a place where the amplitude is not prominent increases.

In the state in which the operation time is short, since a gap between sliding members is small, the main pump 6 vibrates with specific peculiar vibration. In the state in which the operation time is long, since the sliding members wear, the gap between the sliding members increases. Consequently, vibration modes increase and frequency distribution disperses from the specific peculiar vibration to a large number of frequencies. As a result, the amplitude in the place where the amplitude is not prominent increases.

FIG. 4A is a diagram corresponding to the feature value calculating step of step S3. As shown in FIG. 4A, in step S3, the feature-value calculating unit 26 searches for a frequency at which the amplitude exceeds a first determination value 31 in the frequency spectrum 30. The first determination value 31 is not particularly limited. However, for example, the first determination value 31 may be a value obtained by calculating an average 32 and a standard deviation of amplitudes of the frequency spectrum 30 and adding a triple value of the standard deviation to the average 32 of the amplitudes. Besides, the first determination value 31 may be a value determined using an experiment or data accumulated in the past.

Amplitude at a frequency at which the amplitude exceeds the first determination value 31 in the frequency spectrum 30 is represented as Pi. Amplitude of frequencies in the frequency spectrum 30 is represented as Di, where i is an integer starting from 1. The frequencies are numbered in order from the frequency having the lowest frequency.

It is assumed that m is an integer and there are m places of frequencies at which the amplitude exceeds the first determination value 31. In this case, as Pi, there are P1 to Pm. It is assumed that n is an integer and there are n data of the frequency spectrum 30. In this case, as Di, there are D1 to Dn. P, D, and R in the following expressions are calculated. P represents a sum of squares of amplitudes exceeding the first determination value 31. D represents a sum of squares of amplitudes. R represents a feature value used in determining life expiration.

$$\begin{matrix}P = {\sum }_{i = 1}^{m} {P}_{1}^{2} & ( 1 ) \\ D = {\sum }_{i = 1}^{n} {D}_{1}^{2} & ( 2 ) \\ R = \sqrt{P / D} & ( 3 )\end{matrix}$$

The calculation of R is applied to outputs of the X-axis gyro sensor 10a, the Y-axis gyro sensor 10b, and the Z-axis gyro sensor 10c. A value of R in the X-axis gyro sensor 10a is represented as R1 and a value of R in the Y-axis gyro sensor 10b is represented as R2. A value of R in the Z-axis gyro sensor 10c is represented as R3. RM calculated using the following Expression 4 is a combined feature value obtained by combining feature values in the three directions. RM corresponds to the magnitude of vibration irrespective of the direction of the vibration detected by the gyro sensor 10. Therefore, it is possible to calculate a feature value of vibration not affected by the direction of the gyro sensor 10.

RM=\sqrt{R₁²+R₂²+R₃²} (4)

FIGS. 4B and 4C are diagrams corresponding to the life expiration determining step of step S4. In FIGS. 4B and 4C, the ordinate indicates a combined feature value and the abscissa indicates an operation time of the main pump 6. In FIG. 4B, the combined feature value with respect to the operation time at the time when vibration of one main pump 6 is measured is plotted. Plotted places are distributed along an approximate line 33. A second determination value 34 is set from the distribution of combined feature values of the main pump 6 measured in the past. When a combined feature value calculated this time is smaller than the second determination value 34, it can be determined that the main pump 6 is near the life expiration. In this embodiment, the main pump 6 having the combined feature value smaller than the second determination value 34 broke down within 500 hours.

In FIG. 4C, the combined feature value with respect to the operation time at the time when vibration of a plurality of main pumps 6 of the same model is measured is plotted. A first plot 35a to a seventh plot 35g are respectively calculation values of combined feature values in the main pumps 6 different from one another. Plotted places are distributed along the approximate line 33. The second determination value 34 is set from the distribution of combined feature values of the main pumps 6 measured in the past. The main pumps 6 having the combined feature values smaller than the second determination value 34 broke down within 500 hours. According to the data, among the main pumps 6 of the same model, it is possible to determine the main pump 6 using the same second determination value 34. Therefore, it is possible to set the second determination value 34 for each model and determine using the combined feature value and the second determination value 34 that the main pump 6 is near the life expiration. As a result, even if a change with time of the vibration data of the main pump 6 is not checked, it is possible to compare the combined feature value of the measured vibration and the second determination value 34 and determine whether the main pump 6 is near the life expiration.

In the life informing step of step S5, the determining unit 27 displays a determination result on the display device 14. As display content, content concerning whether the main pump 6 is near the life expiration is displayed. Time until the life expiration may be predicted and displayed.

When determining that the main pump 6 is near the life expiration, the determining unit 27 warns the operator visually and auditorily. Consequently, the operator can repair the main pump 6 before the main pump 6 breaks down. The step of predicting life expiration of the apparatus is finished with the contents explained above.

As explained above, according to this embodiment, there are effects explained below.

(1) According to this embodiment, a value of P decreases and a value of D increases as the main pump 6 approaches the life expiration after starting operation. Therefore, a value of the feature value R decreases as the main pump 6 approaches the life expiration. Since there is a correlation between the feature value and the life expiration, it is possible to detect the life expiration of the main pump 6 using the feature value.

The feature value is calculated from a frequency spectrum of a frequency in a predetermined range. Therefore, a determination method can be used for apparatuses having the same structure. Since life expiration is determined with a feature value during measurement, it is possible to predict the life expiration of the main pump 6 even if there is no individual time-series data of the main pump 6.

(2) According to this embodiment, the combined feature value and the second determination value 34 are compared and the life expiration of the main pump 6 is determined. Therefore, it is possible to easily and clearly determine the life expiration.

(3) According to this embodiment, the combined feature value is calculated by combining the feature values in the three directions. Therefore, the combined feature value is data that indicates state of vibrations in all the directions. As a result, it is possible to determine the life expiration of the main pump 6 irrespective of the direction of the gyro sensor 10 with respect to the main pump 6.

(4) According to this embodiment, the gyro sensor 10 is used as the inertial sensor that detects vibration. The feature value obtained using the gyro sensor 10 generally has a larger correlation with the life expiration of the main pump compared with the feature value obtained using the acceleration sensor. Therefore, the life expiration of the main pump 6 can be more easily determined when the gyro sensor 10 is used.

### Second Embodiment

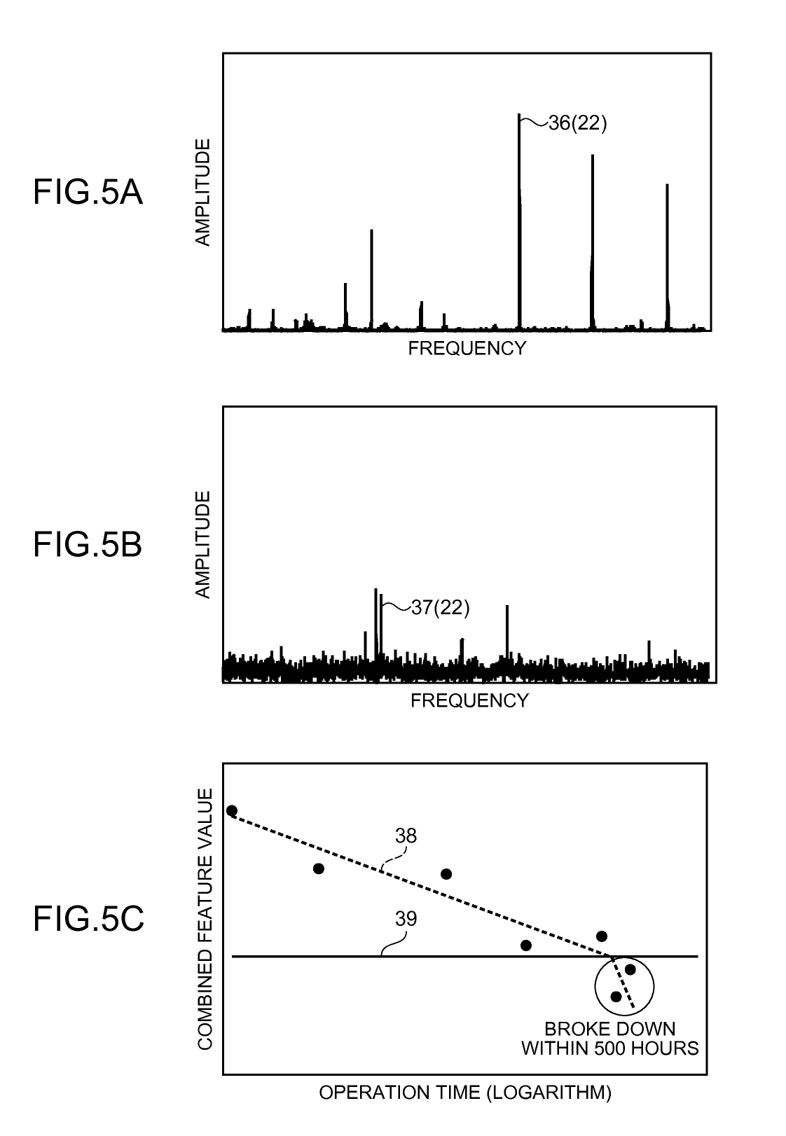

An embodiment of a life expiration predicting apparatus is explained with reference to FIGS. 5A to 5C. This embodiment is different from the first embodiment in that an acceleration sensor is used as a sensor. Concerning similarities to the first embodiment, explanation is omitted.

FIGS. 5A to 5C are diagrams for explaining a life expiration predicting method. A first frequency spectrum 36 shown in FIG. 5A indicates a frequency spectrum of a main pump having a short operation time. The first frequency spectrum 36 is a spectrum equivalent to the first frequency spectrum 28 in the first embodiment. FIG. 5B shows a frequency spectrum of a main pump having a long operation time. In FIGS. 5A and 5B, the abscissa indicates a frequency and the ordinate indicates amplitude. A second frequency spectrum 37 is a spectrum equivalent to the second frequency spectrum 29 in the first embodiment. The first frequency spectrum 36 and the second frequency spectrum 37 are a part of the spectrum data and are frequency spectra calculated by Fourier-transforming a waveform detected using the acceleration sensor.

As indicated by the first frequency spectrum 36, the amplitude of a specific frequency is markedly prominent in the state in which an operation time is short. The amplitude is small at a frequency at a frequency at which the amplitude is not prominent. As indicated by the second frequency spectrum 37, in the state in which the operation time is long, frequencies at which the amplitudes are markedly prominent decrease. The amplitudes of the frequencies are small. The amplitude increases at the frequency at which the amplitude is not prominent. That is, a form of a spectrum that changes according to the operation time is the same as the form of the spectrum obtained when the acceleration sensor is used as the sensor that detects vibration and when the gyro sensor 10 is used as the sensor. Therefore, besides the gyro sensor 10, the acceleration sensor can be used as the sensor that detects vibration.

In FIG. 5C, the ordinate indicates a combined feature value and the abscissa indicates an operation time of the main pump 6. In FIG. 5C, a combined feature value with respect to an operation time at the time when vibration of one main pump 6 is measured is plotted. Plotted places are distributed along an approximate line 38. A second determination value 39 is set from the distribution of combined feature values of the main pump 6 measured in the past. When a combined feature value calculated this time is smaller than the second determination value 39, it can be determined that the main pump 6 is near the life expiration. In this embodiment, the main pump 6 having the combined feature value smaller than the second determination value 39 broke down within 500 hours.

When the combined feature value with respect to the operation time at the time when vibration of a plurality of main pumps 6 of the same model is measured is plotted, plotted places are distributed along an approximate line 38. Therefore, when the acceleration sensor is used as the sensor that detects vibration, it is also possible to set the second determination value 39 for each model and determine using the combined feature value and the second determination value 39 that the main pump 6 is near the life expiration. Since life expiration is determined with a feature value during measurement, it is possible to predict life expiration of the main pump 6 even if there is no time-series data of the main pump 6.

### Third Embodiment

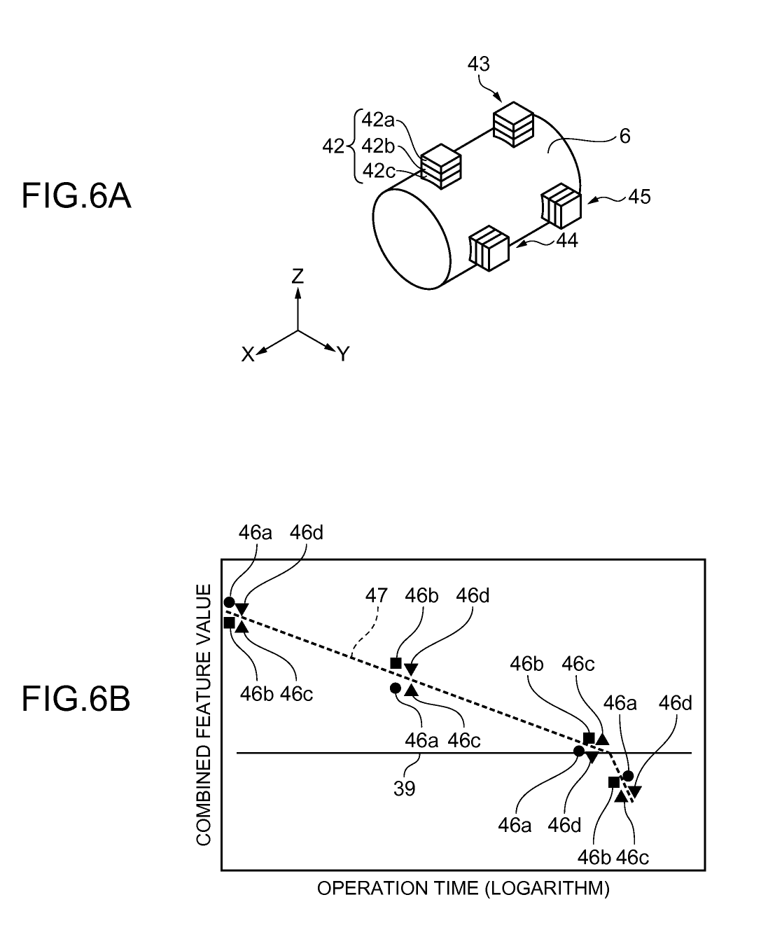

An embodiment of a life expiration predicting apparatus is explained with reference to FIGS. 6A and 6B. This embodiment is different from the second embodiment in that it is indicated whether a difference in a place where an acceleration sensor is set in the main pump 6 affects life expiration prediction. Note that, concerning similarities to the first and second embodiments, explanation is omitted.

FIGS. 6A and 6B are diagrams for explaining a life expiration predicting method. As shown in FIG. 6A, in the main pump 6, four acceleration sensors, i.e., a first acceleration sensor 42, a second acceleration sensor 43, a third acceleration sensor 44, and a fourth acceleration sensor 45 functioning as inertial sensors are set. The acceleration sensors are set in places apart from one another.

The first acceleration sensor 42 includes an X-axis acceleration sensor 42a, a Y-axis acceleration sensor 42b, and a Z-axis acceleration sensor 42c. The X-axis acceleration sensor 42a detects acceleration in the X direction in a place where the first acceleration sensor 42 is set. Similarly, the Y-axis acceleration sensor 42b detects acceleration in the Y direction. The Z-axis acceleration sensor 42c detects acceleration in the Z direction. Consequently, the first acceleration sensor 42 can detect accelerations in the X, Y, and Z directions in the place where the first acceleration sensor 42 is set. The X direction, the Y direction, and the Z directions are directions orthogonal to one another.

Since acceleration corresponds to vibration, the first acceleration sensor 42 can detect vibrations in the X, Y, and Z directions. The second acceleration sensor 43, the third acceleration sensor 44, and the fourth acceleration sensor 45 are configured the same as the first acceleration sensor 42. Therefore, each of the second acceleration sensor 43, the third acceleration sensor 44, and the fourth acceleration sensor 45 can detect vibrations in the three directions orthogonal to one another.

In FIG. 6B, the ordinate indicates a combined feature value and the abscissa indicates an operation time of the main pump 6. In FIG. 6B, the combined feature value with respect to the operation time at the time when vibration of one main pump 6 is measured is plotted. A first plot 46a indicated by a circle indicates a combined feature value of vibration detected by the first acceleration sensor 42. A second plot 46b indicated by a square indicates a combined feature value of vibration detected by the second acceleration sensor 43. A third plot 46c indicated by a triangle indicates a combined feature value of vibration detected by the third acceleration sensor 44. A fourth plot 46d indicated by an inverted triangle indicates a combined feature value of vibration detected by the fourth acceleration sensor 45.

Plotted places of the first plot 46a to the fourth plot 46d are distributed along an approximate line 47. Therefore, vibration detected in the main pump 6 shifts along the same approximate line 47 irrespective of a measurement place. Therefore, even if a measurement place is changed every time vibration is measured, by comparing a combined feature value with the same determination value 39, it is possible to determine whether the main pump 6 is near the life expiration. Therefore, even if a place of a measurement point is changed, it is possible to accurately determine life expiration of the main pump 6.

Note that, even if the sensor is changed from the acceleration sensor to the gyro sensor 10, plots shift along the approximate line 33 in the same manner. Therefore, even if the sensor that detects vibration is changed from the acceleration sensor to the gyro sensor 10, it is possible to change a measurement point every time vibration is measured.

### Fourth Embodiment

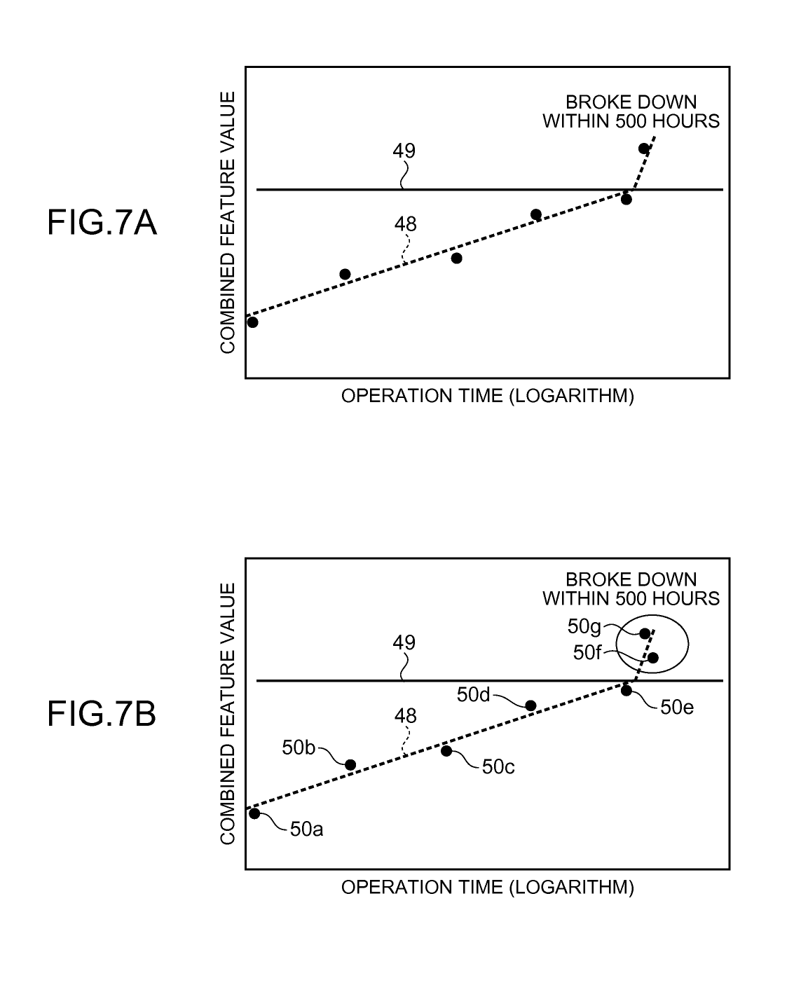

An embodiment of a life expiration predicting apparatus is explained with reference to FIGS. 7A and 7B. This embodiment is different from the first embodiment in that an expression for calculating a feature value is different. Concerning similarities to the first embodiment, explanation is omitted.

In the feature value calculating step of step S3, after P and D are calculated, R is calculated by Expression described below. R is also a feature value used in determining life expiration.

R=\sqrt{(D−P)/D} (5)

Subsequently, a combined feature value RM obtained by combining the feature values in the three directions using Expression 4 is calculated.

FIGS. 7A and 7B are diagrams for explaining a life expiration predicting method. In FIGS. 7A and 7B, the ordinate indicates a combined feature value and the abscissa indicates an operation time of the main pump 6. In FIG. 7A, the combined feature value with respect to the operation time at the time when vibration of one main pump 6 is measured is plotted. Plotted places are distributed along an approximate line 48. A second determination value 49 is set from the distribution of combined feature values of the main pump 6 measured in the past. When a combined feature value calculated this time is larger than the second determination value 49, it can be determined that the main pump 6 is near the life expiration. In this embodiment, the main pump 6 having the combined feature value larger than the second determination value 49 broke down within 500 hours.

In FIG. 7B, the combined feature value with respect to the operation time at the time when vibration of a plurality of main pumps 6 of the same model is measured is plotted. A first plot 50a to a seventh plot 50g are respectively calculation values of combined feature values in the main pumps 6 different from one another. Plotted places are distributed along the approximate line 48. The second determination value 49 is set from the distribution of combined feature values of the main pumps 6 measured in the past. The main pumps 6 having the combined feature values larger than the second determination value 49 broke down within 500 hours. According to the data, among the main pumps 6 of the same model, it is possible to determine the main pump 6 using the same second determination value 49. Therefore, it is possible to set the second determination value 49 for each model and determine using the combined feature value and the second determination value 49 that the main pump 6 is near the life expiration.

As explained above, according to this embodiment, there are effects explained below.

(1) According to this embodiment, a value of P decreases and a value of D increases as the main pump 6 approaches the life expiration after starting operation. Therefore, a value of the feature value R approaches 1 as the main pump 6 approaches the life expiration. Since there is a correlation between the feature value and the life expiration, it is possible to detect the life expiration of the main pump 6 using the feature value.

(2) According to this embodiment, the feature value is calculated from a frequency spectrum of a frequency in a predetermined range. Therefore, a determination method can be used for the main pumps 6 having the same structure. Since life expiration is determined with a feature value during measurement, it is possible to predict the life expiration of the main pump 6 even if there is no individual time-series data of the main pump 6.

### Fifth Embodiment

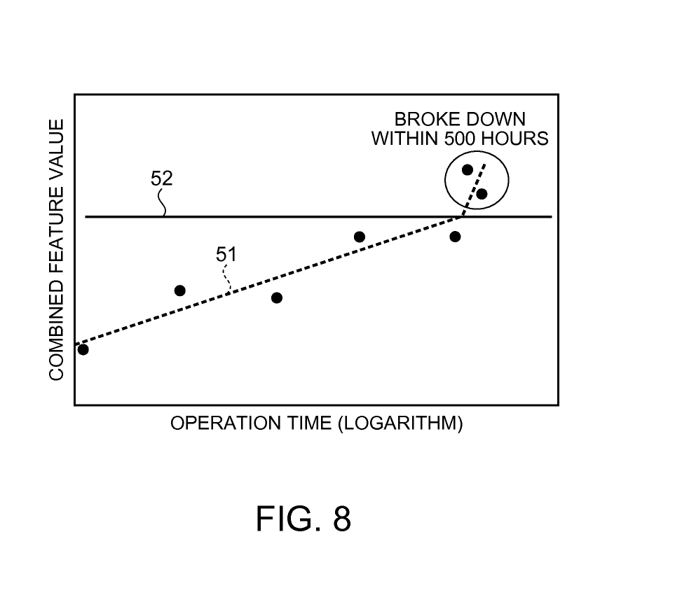

An embodiment of a life expiration predicting apparatus is explained with reference to FIG. 8. This embodiment is different from the fourth embodiment in that an acceleration sensor is used as a sensor. Concerning similarities to the fourth embodiment, explanation is omitted.

FIG. 8 is a diagram for explaining a life expiration predicting method. In FIG. 8, the ordinate indicates a combined feature value and the abscissa indicates an operation time of the main pump 6. In FIG. 8, the combined feature value with respect to the operation time at the time when vibration of one main pump 6 is measured is plotted. The combined feature value is a combined feature value calculated using Expression by Fourier-transforming a waveform detected using the acceleration sensor. Plotted places are distributed along an approximate line 51 according to a calculation result. A second determination value 52 is set from the distribution of combined feature values of the main pump 6 measured in the past. When a calculated combined feature value is larger than the second determination value 52, it can be determined that the main pump 6 is near the life expiration. In this embodiment, the main pump 6 having the combined feature value larger than the second determination value 52 broke down within 500 hours.

When the combined feature value with respect to the operation time at the time when vibration of a plurality of main pumps 6 of the same model is measured is plotted, plotted places are distributed along an approximate line 51. Therefore, when the acceleration sensor is used as the sensor that detects vibration, it is also possible to set the second determination value 52 for each model and determine using the combined feature value and the second determination value 52 that the main pump 6 is near the life expiration. Since life expiration is determined with a feature value during measurement, it is possible to predict life expiration of the main pump 6 even if there is no time-series data of the main pump 6.

### Sixth Embodiment

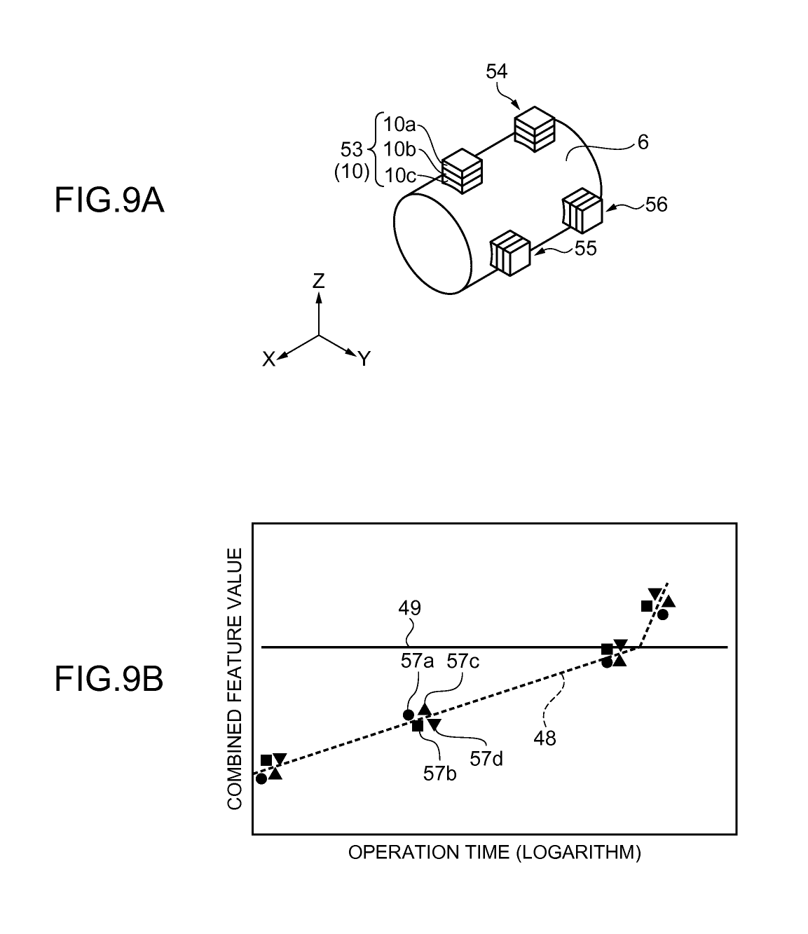

An embodiment of a life expiration predicting apparatus is explained with reference to FIGS. 9A and 9B. This embodiment is different from the fourth embodiment in that a place where the gyro sensor 10 is set in the main pump 6 is different. Concerning similarities to the first to fifth embodiments, explanation is omitted.

FIGS. 9A and 9B are diagrams for explaining a life expiration predicting method. As shown in FIG. 9A, in the main pump 6, four gyro sensors 10, i.e., a first gyro sensor 53, a second gyro sensor 54, a third gyro sensor 55, and a fourth gyro sensor 56 functioning as inertial sensors are set. The gyro sensors are set in places apart from one another.

The gyro sensor 10 detects angular velocities around axes extending in three directions orthogonal to one another. Therefore, the first gyro sensor 53 to the fourth gyro sensor 56 can detect angular velocities around axes in all directions. Since angular velocity corresponds to vibration, each of the first gyro sensor 53 to the fourth gyro sensor 56 can detect vibrations in the three directions.

In FIG. 9B, the ordinate indicates a combined feature value and the abscissa indicates an operation time of the main pump 6. In FIG. 9B, the combined feature value with respect to the operation time at the time when vibration of one main pump 6 is measured by the first gyro sensor 53 to the fourth gyro sensor 56 is plotted. Note that the combined feature value is a combined feature value obtained by the calculation of Expression 5. A first plot 57a indicated by a circle indicates a combined feature value of vibration detected by the gyro sensor 53. A second plot 57b indicated by a square indicates a combined feature value of vibration detected by the second gyro sensor 54. A third plot 57c indicated by a triangle indicates a combined feature value of vibration detected by the third gyro sensor 55. A fourth plot 57d indicated by an inverted triangle indicates a combined feature value of vibration detected by the fourth gyro sensor 56.

Plotted places of the first plot 57a to the fourth plot 57d are distributed along an approximate line 48. Therefore, vibration detected in the main pump 6 shifts along the same approximate line 48 irrespective of a measurement place. Therefore, even if a measurement place is changed every time vibration is measured, by comparing a combined feature value with the same determination value 49, it is possible to determine whether the main pump 6 is near the life expiration.

Note that, even if the sensor is changed from the gyro sensor 10 to the acceleration sensor, plots shift along the approximate line 51 in the same manner. Therefore, even if the sensor that detects vibration is changed from the gyro sensor 10 to the acceleration sensor, it is possible to change a measurement point every time vibration is measured.

### Seventh Embodiment

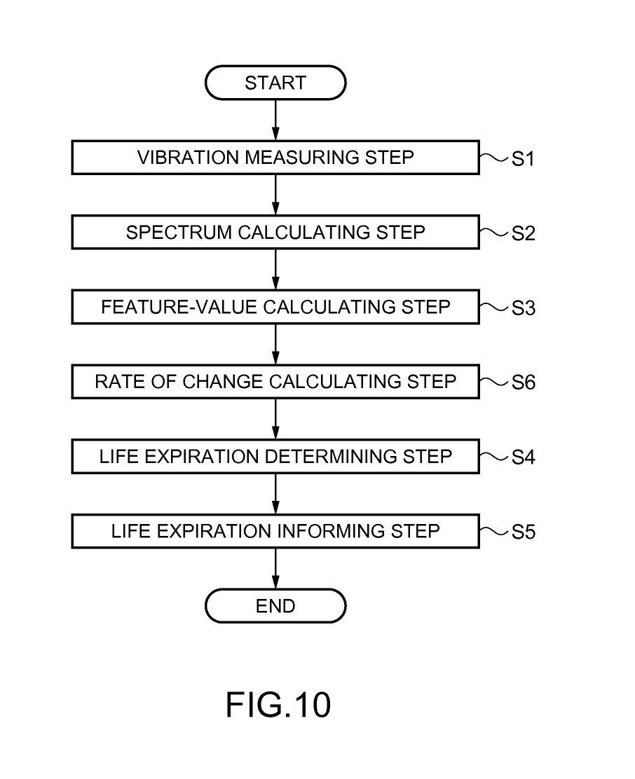

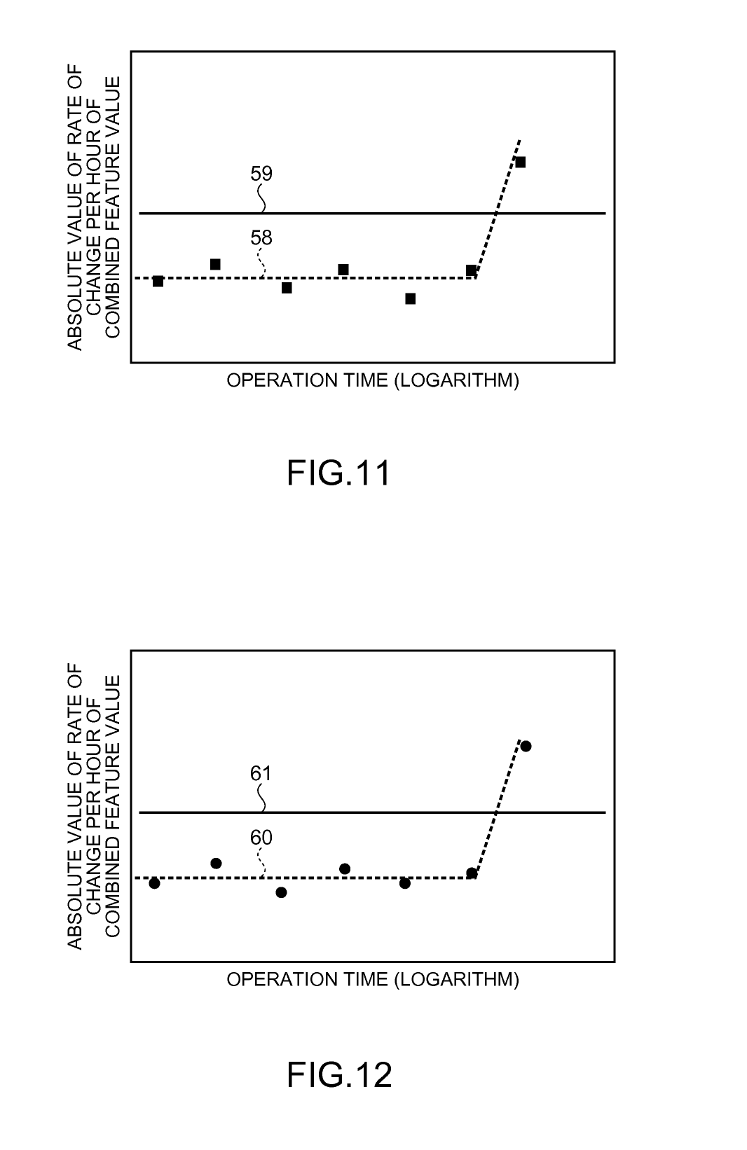

An embodiment of a life expiration predicting apparatus is explained with reference to FIGS. 10 and 11. This embodiment is different from the second embodiment in that attention is directed to a rate of change of a combined feature value of the main pump 6. In this embodiment, an acceleration sensor is used as a sensor. Note that, concerning similarities to the first to sixth embodiments, explanation is omitted.

FIG. 10 is a flowchart for explaining a life expiration predicting method. FIG. 11 is a diagram for explaining the life expiration predicting method. In FIG. 10, in a vibration measuring step of step S1, vibration is detected using the acceleration sensor and a vibration waveform is output. In a feature value calculating step of step S3, a feature value is calculated using Expression 3 and a combined feature value is calculated using Expression 4. A rate of change calculating step of step S6 is performed after a feature value calculating step of step S3. In step S6, a rate of change of the combined feature value calculated in step S3 is calculated.

A combined feature value calculated by measuring vibration last time is represented as RM1. A combined feature value calculated by measuring vibration this time is represented as RM2. A period between the measurement of the last time and the measurement of this time is represented as T. A rate of change H is calculated by Expression 6 below.

H=(RM2−RM1)/T (6)

In a life expiration determining step of step S4, determination is performed using a calculation result of Expression 6. In FIG. 11, the ordinate indicates an absolute value of a rate of change per hour of a combined feature value and the abscissa indicates an operation time of the main pump 6. In FIG. 11, an absolute value of the rate of change H per hour of the combined feature value with respect to the operation time at the time when vibration of one main pump 6 is measured is plotted. Note that the absolute value of a rate of change per hour of a combined feature value is an absolute value of the rate of change H obtained by the calculation of Expression 6.

When the absolute value of the rate of change H with respect to the operation time is plotted, plotted places are distributed along an approximate line 58. The approximate line 58 suddenly rises when the main pump 6 is near the life expiration. Therefore, when the absolute value of the rate of change H is used, it is also possible to set a second determination value 59 for each model and determine using the absolute value of the rate of change H and the second determination value 59 that the main pump 6 is near the life expiration.

Note that, when the gyro sensor 10 is used as the sensor, an approximate line of plots obtained by performing the same calculation has a shape same as the approximate line 58. Therefore, it is possible to set the second determination value for each model using the absolute value of the rate of change H and determine using the absolute value of the rate of change H and the second determination value that the main pump 6 is near the life expiration.

As explained above, according to this embodiment, there is an effect explained below.

(1) According to this embodiment, the change rate of the feature value with respect to the operation time is calculated. The life expiration of the main pump 6 is determined using the rate of change. The rate of change increases as the main pump 6 approaches the life expiration. Therefore, it is possible to make it easy to determine life expiration by using the rate of change.

### Eighth Embodiment

An embodiment of a life expiration predicting apparatus is explained with reference to FIG. 12. FIG. 12 is a diagram for explaining a life expiration predicting method. This embodiment is different from the seventh embodiment in that the gyro sensor 10 is used as the sensor and Expression 5 is used for calculation of a combined feature value of the main pump 6. Note that, concerning similarities to the first to seventh embodiments, explanation is omitted.

That is, in the vibration measuring step of step S1, vibration is detected and a vibration waveform is output using the gyro sensor 10. In the feature value calculating step of step S3, the feature value R is calculated using Expression 5. The combined feature value RM is calculated from the feature value R. In the rate of change calculating step in step S6, an absolute value of the rate of change H is calculated by Expression 6 using the combined feature value RM.

In the life expiration determining step of step S4, determination is performed using a calculation result of Expression 6. In FIG. 12, the ordinate indicates an absolute value of a rate of change per hour of a combined feature value and the abscissa indicates an operation time of the main pump 6. In FIG. 12, an absolute value of the rate of change H with respect to the operation time at the time when vibration of one main pump 6 is measured is plotted. Note that the absolute value of the rate of change per hour of the combined feature value is an absolute value of the rate of change H obtained by the calculation of Expression 5.

When the absolute value of the rate of change H with respect to the operation time is plotted, plotted places are distributed along an approximate line 60. The approximate line 60 suddenly rises when the main pump 6 is near the life expiration. Therefore, when the absolute value of the rate of change H is used, it is also possible to set a second determination value 61 for each model and determine using the absolute value of the rate of change H and the second determination value 61 that the main pump 6 is near the life expiration.

Note that, when the acceleration sensor is used as the sensor, the same calculation is performed. An approximate line of obtained plots has a shape similar to the approximate line 58. Therefore, it is possible to set the second determination value for each model using the absolute value of the rate of change H and determine using the absolute value of the rate of change H and the second determination value that the main pump 6 is near the life expiration.

### Ninth Embodiment

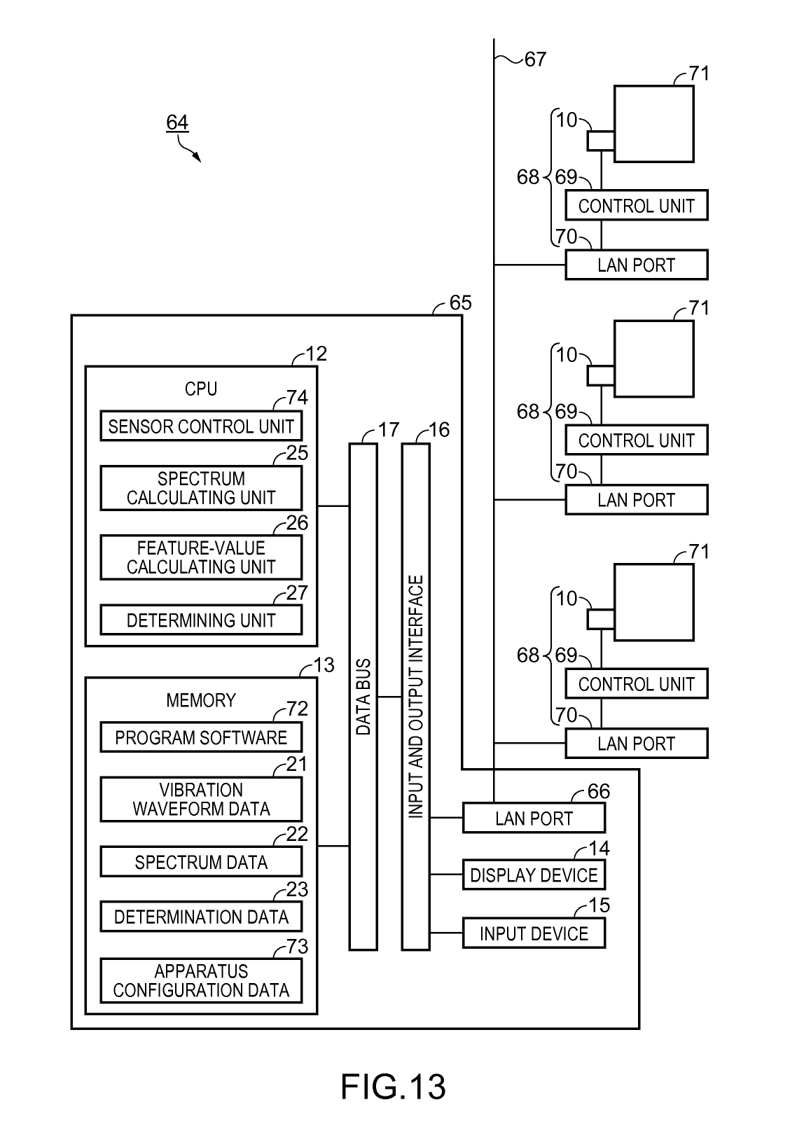

An embodiment of a life expiration predicting apparatus is explained with reference to FIG. 13. FIG. 13 is a block diagram showing the configuration of a life expiration predicting system. This embodiment is different from the first embodiment in that a portion including a calculation function is set in a server and data of the gyro sensor 10 is transferred via a network. Note that, concerning similarities to the first to eighth embodiment, explanation is omitted.

As shown in FIG. 13, a life expiration predicting system 64 includes a life expiration calculation server 65 as a life expiration calculating apparatus. The life expiration calculation server 65 includes a LAN (Local Area Network) port 66 functioning as a receiving unit. A LAN 67 functioning as a network is connected to the LAN port 66. A plurality of vibration detecting apparatuses 68 are connected to the LAN 67. The number of the vibration detecting apparatuses 68 connected to the LAN 67 is not particularly limited. However, in an example shown in the figure, three vibration detecting apparatuses 68 are set. The vibration detecting apparatus 68 includes the gyro sensor 10, a control unit 69, and a LAN port 70 functioning as a transmitting unit. As the LAN 67, besides a wired LAN, a wireless LAN and a controller area network can be used.

The LAN port 70 has a function of an interface that receives an instruction from the life expiration calculation server 65 via the LAN 67 and outputs the vibration waveform data 21 to the life expiration calculation server 65. The control unit 69 receives an instruction from the life expiration calculation server 65 and drives the gyro sensor 10. The control unit 69 outputs the detected vibration waveform data 21 to the life expiration calculation server 65 via the LAN port 70. The vibration detecting apparatus 68 is set in a rotary machine 71 functioning as a detection target apparatus. The rotary machine 71 includes a rotating mechanism such as a motor or a pump. The gyro sensor 10 is set in the rotary machine 71 and detects vibration of the rotary machine 71. The vibration detecting apparatus 68 transmits the vibration waveform data 21 of the rotary machine 71 detected by the gyro sensor 10 to the life expiration calculation server 65. Note that an acceleration sensor may be set in the vibration detecting apparatus 68 instead of the gyro sensor 10.

The life expiration calculation server 65 includes, besides the LAN port 66, the display device 14, the input device 15, the input and output interface 16, the data bus 17, the CPU 12, and the memory 13. The LAN port 66 receives data of vibration transmitted by the vibration detecting apparatus 68 and outputs the data to the CPU 12 or the memory 13 via the input and output interface 16 and the data bus 17.

In the memory 13, a storage area in which program software 72, the vibration waveform data 21, the spectrum data 22, the determination data 23, apparatus configuration data 73, and the like are stored is set. The program software 72 is data indicating a procedure of operation in the CPU 12. The CPU 12 performs various arithmetic operations on the basis of the program software 72. The apparatus configuration data 73 is data related to the vibration detecting apparatus 68 and the rotary machine 71 connected to the LAN 67.

The CPU 12 includes a sensor control unit 74, the spectrum calculating unit 25, the feature-value calculating unit 26, and the determining unit 27. The sensor control unit 74 outputs, on the basis of a predetermined vibration detection schedule and the apparatus configuration data 73, an instruction signal for measuring vibration to the vibration detecting apparatus 68. The sensor control unit 74 receives the vibration waveform data 21 of the rotary machine 71 output by the vibration detecting apparatuses 68 and stores the vibration waveform data 21 in the memory 13.

The spectrum calculating unit 25 receives the vibration waveform data 21 from the memory 13, calculates the spectrum data 22, and stores the spectrum data 22 in the memory 13. The feature-value calculating unit 26 receives the spectrum data 22, performs the calculation of Expressions 1 to 5, and calculates a combined feature value. The feature-value calculating unit 26 may calculate a feature value using Expression 3 or may calculate a feature value using Expression 5. The feature-value calculating unit 26 calculates the combined feature value and stores the combined feature value in the memory 13 as the determination data 23. The determining unit 27 compares the combined feature value with a second determination value, determines whether the rotary machine 71 is near the life expiration, and displays a determination result on the display device 14.

As explained above, according to this embodiment, there is an effect explained below.

(1) According to this embodiment, the vibration detecting apparatus 68 and the life expiration calculation server 65 are connected via the LAN 67. Therefore, when the plurality of vibration detecting apparatuses 68 are connected to the LAN 67, the life expiration calculation server 65 can also determine life expiration of a plurality of rotary machines 71.

Note that embodiments of the invention are not limited to the embodiments explained above. Various changes and improvements can be added by those having ordinary knowledge in the field within the technical idea of the invention. Modifications are explained below.

### Modification 1

In the first embodiment, the gyro sensor 10 is set in the main pump 6 of the dry etching apparatus 1. The gyro sensor 10 may be applied to a plasma CVD apparatus instead of the dry etching apparatus 1. In this case, TEOS (Tetraethyl orthosilicate) or Si(OC3H5)4 is used as a material gas. Gas including SiO2 is generated by film forming treatment. When the main pump 6 and the roughing vacuum pump 7 operate, product materials such as SiO2 accumulate in the main pump 6 and the roughing vacuum pump 7. When the accumulation of the product materials increases, the main pump 6 and the roughing vacuum pump 7 cause a malfunction. In this case, the life expiration predicting apparatus 9 can also detect whether the main pump 6 and the roughing vacuum pump 7 are near the life expiration. Note that this content can also be applied to the other embodiments.

### Modification 2

In the first embodiment, Expression 3 is used to calculate the feature value R. The feature value may be calculated using Expression 7 in which a square root of Expression 3 is removed.

R=P/D (7)

A second determination value corresponding to the feature value calculated by Expression 7 may be set. Calculation of a square root is omitted in the calculation of “R=P/D” of Expression 7 compared with the calculation of the expression “R=√(P/D)” of Expression 3. Therefore, a calculation time can be reduced. In this case, since there is a correction between the feature value and the life expiration, it is also possible to detect the life expiration of the main pump 6 using the feature value. Since life expiration is determined with a feature value during measurement, it is possible to predict the life expiration of the main pump 6 even if there is no individual time-series data of the main pump 6. Note that this content can also be applied to the second, third, seventh, and ninth embodiments.

### Modification 3

In the fourth embodiment, Expression 5 is used to calculate the feature value R. The feature value may be calculated using Expression 8 in which a square root of Expression 5 is removed.

R=(D−P)/D (8)

A second determination value corresponding to the feature value calculated by Expression 8 may be set. Calculation of a square root is omitted in the calculation of “R=(D−P)/D” of Expression 8 compared with the calculation of the expression “R=√(D−P)/√D” of Expression 5. Therefore, a calculation time can be reduced. In this case, since there is a correction between the feature value and the life expiration, it is also possible to detect the life expiration of the main pump 6 using the feature value. Since life expiration is determined with a feature value during measurement, it is possible to predict the life expiration of the main pump 6 even if there is no individual time-series data of the main pump 6. Note that this content can also be applied to the fifth, sixth, eighth, and ninth embodiments.

### Modification 4

In the first embodiment, the gyro sensor 10 detects angular velocities around the axes extending in the three directions orthogonal to one another. The three directions may cross on another rather than being orthogonal to one another. It is possible to calculate components in the three directions orthogonal to one another by learning crossing angels of the axes in advance. Similarly, in the third embodiment, the first acceleration sensor 42 to the fourth acceleration sensor 45 detect accelerations in the three directions orthogonal to one another. The three directions may cross on another rather than being orthogonal to one another. It is possible to calculate acceleration components in the three directions orthogonal to one another by learning crossing angels of the axes in advance. Consequently, it is possible to easily set the sensors. Note that this content can also be applied to the other embodiments.

### Modification 5

In the first embodiment, the gyro sensor 10 detects angular velocities around the axes extending in the three directions. The number of detecting directions is not limited to three and may be one, two, and four or more. The number of detecting directions may be set according to a state of vibration. Similarly, in the third embodiment, accelerations in the three directions are detected. The number of detecting directions is not limited to three and may be one, two, and four or more and may be set according to a state of vibration. As the number of detecting directions is smaller, the number of sensors may be smaller. Therefore, it is easier to manufacture an apparatus. As the number of detecting direction is larger, it is possible to improve accuracy. Note that this content can also be applied to the other embodiments.

### Modification 6

In the first embodiment, the gyro sensor 10 and the arithmetic device 11 are connected by the wire. The gyro sensor 10 and the arithmetic apparatus 11 may be connected by radio. Relative positions of the gyro sensor 10 and the arithmetic device 11 can be easily changed. The arithmetic device 11 is made portable and the gyro sensors 10 are set in a plurality of main pumps 6. Consequently, it is possible to detect life expirations of the plurality of main pumps 6 with one arithmetic device 11. For radio communication, ZigBee (registered trademark) and Bluetooth (registered trademark) may be used. When wired communication is performed, a Universal Serial bus may be used.

### Modification 7

In the first embodiment, when it is determined that the main pump 6 is near the life expiration, a determination result is displayed on the display device 14. Besides, an interface connected to the main pump 6 may be provided. When it is determined that the main pump 6 is near the life expiration, the life expiration predicting apparatus 9 may stop the main pump 6. Note that this content can also be applied to the other embodiments. In the ninth embodiment, the control unit 69 may include a function of stopping the rotary machine 71. When it is determined that the rotary machine 71 is near the life expiration, the life expiration calculation server 65 may cause the control unit 69 to stop the rotary machine 71.

### Modification 8

In the first embodiment, the life expiration of the main pump 6 is determined using the combined feature value. The life expiration of the main pump 6 may be determined with the feature value before being combined. The combined feature value or the feature value before being combined may be selected according to a characteristic of an apparatus, life expiration of which is detected. Consequently, since items to be calculated decreases, it is possible to reduce a calculation time.

### Modification 9

In the first embodiment, in the gyro sensor 10, the X-axis gyro sensor 10a, the Y-axis gyro sensor 10b, and the Z-axis gyro sensor 10c are set to be laid one on top of another. The X-axis gyro sensor 10a, the Y-axis gyro sensor 10b, and the Z-axis gyro sensor 10c may be arranged side by side or may be arranged to be easily set. Angular velocity can be detected in the same manner. When acceleration sensors are used, the acceleration sensors may be arranged to be easily set.

### Modification 10

In the first embodiment, the life expiration of the main pump 6 is determined using the combined feature value. As a machine, life expiration of which is predicted, the invention can also be applied to motors, rotating mechanisms, and the like of a cooling water pump, a blower, a wire saw, and a grinder.

The entire disclosure of Japanese Patent Application No. 2013-231917, filed Nov. 8, 2013 is expressly incorporated by reference herein.

What is claimed is:

1. A life expiration predicting method comprising:
subjecting a vibration waveform output by an inertial sensor set in a detection target apparatus to a frequency analysis and calculating a frequency spectrum;
calculating a feature value using the frequency spectrum; and
determining life expiration of the detection target apparatus on the basis of the feature value, wherein
when the feature value is represented as R, a sum of squares of amplitudes in the frequency spectrum is represented as D, and a sum of squares of the amplitudes exceeding a first determination value is represented as P, R=√(P/D).

2. A life expiration predicting method comprising:
subjecting a vibration waveform output by an inertial sensor set in a detection target apparatus to a frequency analysis and calculating a frequency spectrum;
calculating a feature value using the frequency spectrum; and
determining life expiration of the detection target apparatus on the basis of the feature value, wherein
when the feature value is represented as R, a sum of squares of amplitudes in the frequency spectrum is represented as D, and a sum of squares of the amplitudes exceeding a first determination value is represented as P, R=√(D−P)/√D.

3. The life expiration predicting method according to claim 1, wherein
a rate of change of the feature value with respect to an operation time is calculated, and
the life expiration of the detection target apparatus is determined using the rate of change.

4. The life expiration predicting method according to claim 2, wherein
a rate of change of the feature value with respect to an operation time is calculated, and
the life expiration of the detection target apparatus is determined using the rate of change.

5. The life expiration predicting method according to claim 1, wherein the feature value and a second determination value are compared to determine the life expiration of the detection target apparatus.

6. The life expiration predicting method according to claim 2, wherein the feature value and a second determination value are compared to determine the life expiration of the detection target apparatus.

7. The life expiration predicting method according to claim 1, wherein
the vibration waveform output by the inertial sensor includes vibration components of the detection target apparatus in a first direction, a second direction, and a third direction orthogonal to one another,
the life expiration predicting method further comprises:
calculating the frequency spectrums and the feature values in the first direction, the second direction, and the third direction;
calculating a combined feature value using the feature values in the first direction, the second direction, and the third direction; and
determining the life expiration of the detection target apparatus using the combined feature value, and
when the feature value calculated using the vibration waveform in the first direction is represented as R1, the feature value calculated using the vibration waveform in the second direction is represented as R2, and the feature value calculated using the vibration waveform in the third direction is represented as R3, RM=\sqrt{R₁²+R₂²+R₃²} is set as the combined feature value.

8. The life expiration predicting method according to claim 2, wherein
the vibration waveform output by the inertial sensor includes vibration components of the detection target apparatus in a first direction, a second direction, and a third direction orthogonal to one another,
the life expiration predicting method further comprises:
calculating the frequency spectrums and the feature values in the first direction, the second direction, and the third direction;
calculating a combined feature value on the basis of the feature values in the first direction, the second direction, and the third direction; and
determining the life expiration of the detection target apparatus using the combined feature value, and
when the feature value calculated using the vibration waveform in the first direction is represented as R1, the feature value calculated using the vibration waveform in the second direction is represented as R2, and the feature value calculated using the vibration waveform in the third direction is represented as R3, RM=\sqrt{R₁²+R₂²+R₃²} is set as the combined feature value.

9. A life expiration predicting method comprising:
subjecting a vibration waveform output by an inertial sensor set in a detection target apparatus to a frequency analysis and calculating a frequency spectrum;
calculating a feature value using the frequency spectrum; and
determining life expiration of the detection target apparatus on the basis of the feature value, wherein
when the feature value is represented as R, a sum of squares of amplitudes in the frequency spectrum is represented as D, and a sum of squares of the amplitudes exceeding a first determination value is represented as P, R=P/D.
